(19) United States
(12) Patent Application Publication
(10) Pub. No.: US 2015/0235122 A1
(43) Pub. Date: Aug. 20, 2015

(54) DUAL INTERFACE CARD WITH METALLIZED LAYER

(71) Applicants: David Finn, Tourmakeady County Mayo (IE); Klaus Ummenhofer, Kaufbeuren (DE)

(72) Inventors: David Finn, Tourmakeady County Mayo (IE); Klaus Ummenhofer, Kaufbeuren (DE)

(21) Appl. No.: 14/564,111

(22) Filed: Dec. 9, 2014

Related U.S. Application Data
(63) Continuation-in-part of application No. 14/225,570, filed on Mar. 26, 2014.
Application No. 14/225,570 is a continuation-in-part of application No. 13/600,140, filed on Aug. 30, 2012, now Pat. No. 8,991,712.
Application No. 13/600,140 is a continuation-in-part of application No. 14/020,884, filed on Sep. 8, 2013, now Pat. No. 9,033,250.
Application No. 14/020,884 is a continuation-in-part of application No. 14/173,815, filed on Feb. 6, 2014.
Application No. 14/173,815 is a continuation-in-part of application No. 13/744,686, filed on Jan. 18, 2013, now abandoned.
Application No. 13/744,686 is a continuation-in-part of application No. 14/078,527, filed on Nov. 13, 2013.
Application No. 14/078,527 is a continuation-in-part of application No. 14/281,876, filed on May 19, 2014.
(60) Provisional application No. 61/914,996, filed on Dec. 12, 2013.
(60) Provisional application No. 62/006,085, filed on May 31, 2014.
(60) Provisional application No. 61/697,825, filed on Sep. 7, 2012.
(60) Provisional application No. 61/905,134, filed on Nov. 15, 2013.

(51) Int. Cl. G06K 19/077; G06K 7/10

(52) U.S. Cl. CPC G06K 19/07794; G06K 19/07754; G06K 7/10009

(57) ABSTRACT

Card body (CB) for a dual interface smart card (SC) comprising a metal foil (MF) or metallized layer (ML). An opening in the metal layer may be sized so that a coupler coil (CC) of a booster antenna (BA) is exposed. Improving coupling between a contactless reader and a transponder comprising providing a patch booster antenna (PBA) on a substrate disposed on the reader. Various booster antenna designs are disclosed.

### CROSS-REFERENCES TO RELATED APPLICATIONS

Priority is claimed from the following US applications
nonprovisional of 61/914,996 filed 12 Dec. 2013
continuation-in-part of Ser. No. 14/225,570 filed 26 Mar. 2014 which claims priority from 61936356 6 Feb. 2014
nonprovisional of 62/006,085 filed 31 May 2014
continuation-in-part of Ser. No. 13/600,140 filed 30 Aug. 2012 (20130075477, 28 Mar. 2013)
continuation-in-part of Ser. No. 14/020,884 filed 8 Sep. 2013 (20140091149, 03 Apr. 2014) which claims priority from U.S. 61/697,825 filed 7 Sep. 2012
continuation-in-part of Ser. No. 14/173,815 filed 6 Feb. 2014 which claims priority from 61/905,134 filed 15 Nov. 2013
continuation-in-part of Ser. No. 13/744,686 filed 18 Jan. 2013 (US 20130126622, 23 May 2013
continuation-in-part of Ser. No. 14/078,527 filed 13 Nov. 2013
continuation-in-part of Ser. No. 14/281,876 filed 19 May 2014 (20140284386 25 Sep. 2014)

### TECHNICAL FIELD

The disclosure relates to “secure documents” such as electronic passports, electronic ID cards and smartcards (or smart cards, data carriers, chip cards, payment cards, and the like) having RFID (radio frequency identification) chips or chip modules (CM) capable of operating in a “contactless” mode (ISO 14443) including dual interface (DI) smartcards and secure documents which can also operate in contact mode (ISO 7816-2) and, more particularly, to booster antennas (BA) which may comprise various antenna components, such as a card antenna (CA) component for coupling with an external contactless reader, and a coupling coil (CC) component for coupling with the module antenna (MA) of an antenna module (AM) comprising dual interface RFID chip or chip module (CM).

### BACKGROUND

A dual interface (DI or DIF) smart card may generally comprise:
an antenna module AM,
a card body CB, and
a booster antenna BA.

The antenna module “AM” may generally comprise a “DI” RFID chip (bare, unpackaged silicon die) or chip module (a die with leadframe, carrier or the like)—either of which may be referred to as “CM”—mounted to a module tape “MT”. A module antenna MA may be disposed on the module tape MT for implementing a contactless interface. Contact pads “CP” may be disposed on the module tape MT for implementing the contact interface. The module tape MT may comprise a pattern of interconnects (conductive traces and pads) to which the chip CM and contact pads CP may be connected.

The card body CB—which may be referred to as a substrate, or an inlay substrate—may generally comprise one or more layers of material such as Polyvinyl Chloride (PVC), Polycarbonate (PC), PET-G (Polyethylene Terephtalate Glycol-modified), Copolyester (Tritan), Teslin™, synthetic paper, paper and the like. The card body CB may be generally rectangular, measuring approximately 54 mm×86 mm (refer to ISO/IEC 7810), having a thickness of approximately 300 μm thick. The card body CB is typically significantly (such as 20 times) larger than the antenna module AM.

The booster antenna BA may generally comprise a relatively large winding which may be referred to as a card antenna CA component (or portion) having a number of turns disposed in a peripheral area of the card body CB, and a relatively small coupler coil (or coupler antenna) CC component (or portion) having a number of turns disposed at a coupling area of the card body CB corresponding to the antenna module AM.

The card antenna CA and coupler coil CC may comprise wire mounted to (embedded in) the card body CB using an ultrasonic tool comprising a sonotrode and a capillary. See, for example U.S. Pat. No. 6,698,089 and U.S. Pat. No. 6,233,818. The wire may be non-insulated, insulated, or self-bonding wire, having an exemplary diameter in the range of approximately 50-112 μm.

### Some References

NL 9100347 (1992, Nedap) discloses a contactless card having the following elements arranged as shown in Figuur 1; (1) geintegreerde schakeling (integrated circuit); (2) electronische schakeling (electronic circuit); (3) transformator (transformer); (4) kernmateriaal (core material); (5) condensator (condenser); (6) primaire spoel (primary coil) and (7) antennespoel (antenna coil)

As is evident from Figuur 1 of the Nedap patent, the electronic circuit (2, comparable to the chip CM herein) is connected with a first coil (3, comparable to the module antenna MA herein). A second coil (6, comparable to the coupling coil CC herein) is connected with the main antenna (1, comparable to the card antenna CA herein). The first coil (3, MA) is coupled with the second coil (6, CC), as aided by the core material (4).

U.S. Pat. No. 5,955,723 (Siemens; 1999), incorporated by reference herein, discloses a contactless chip card. A data carrier configuration includes a semiconductor chip. A first conductor loop is connected to the semiconductor chip and has at least one winding and a cross-sectional area with approximately the dimensions of the semiconductor chip. At least one second conductor loop has at least one winding, a cross-sectional area with approximately the dimensions of the data carrier configuration and a region forming a third loop with approximately the dimensions of the first conductor loop. The third loop inductively couples the first conductor loop and the at least one second conductor loop to one another. The first and third conductor loops are disposed substantially concentrically. FIGS. 1 and 2 illustrate that a large coil, that is to say a second conductor loop 3, has approximately the dimensions of a chip card. FIG. 1 illustrates a way of forming the small loop 4 of the large coil 3 without any crossovers, whereas FIG. 2 illustrates a small loop 4 having a crossover. FIG. 3 shows a further possible configuration of a coupling region between a small conductor loop 2 connected to a semiconductor chip 1, and a large conductor loop 3. In this case, the coupling region has a meandering path, in order to obtain as long a length of the coupling region as possible.

U.S. Pat. No. 8,130,166 (Assa Abloy; 2012), incorporated by reference herein, discloses coupling device for transponder and smart card with such device. A coupling device is formed by a continuous conductive path having a central section and two extremity sections, the central section forming at least a small spiral for inductive coupling with the transponder device, the extremities sections forming each one large spiral for inductive coupling with the reader device, wherein the small spiral shows a larger pitch than the ones of the large spirals, and wherein the two extremities of the continuous path are loose such that the coupling device forms an open circuit. The pitches of the large spirals are chosen such as that the interturn stray capacitances is important and that the large spirals have mainly a capacitive behavior. And the pitch of the small spiral is chosen such as that the interturn stray capacitances are negligible, and that the small spiral has mainly an inductive behavior. FIG. 3 shows an illustrative embodiment of the transponder device and coupling device. The coupling device 10 is formed by a single conductive path having a central section and two external sections. The central portion is formed as a small spiral 12 with a large pitch, whereas the two external sections form a large spiral 11 and 11′ with a small pitch. In fact, the spiral 11 and 11′ are two distinct spiral physical elements, but forming a single geometrical spiral element (with a short interruption in the middle).

US 20130146671 (Infineon; 2013), incorporated by reference herein, discloses a booster antenna structure for a chip card is provided, wherein the booster antenna structure may include a booster antenna; and an additional electrically conductive structure connected to the booster antenna.

The contactless interface on the chip card can have a chip card antenna which is contained in the chip card and connected to the chip.

In order to improve the wireless communication capability, a further antenna can be provided in addition to the chip card module antenna, namely an amplifier antenna or booster antenna.

U.S. Pat. No. 8,474,726 (Finn; 2013) discloses a transponder with an antenna module having a chip module and an antenna; a booster antenna having a first antenna structure in the form of a flat coil having a number of turns, an outer end and an inner end, and a second antenna structure in the form of a flat coil having a number of turns, an outer end and an inner end; the inner end of the second antenna structure connected with the outer end of the first antenna structure. The antenna module may be positioned so that its antenna overlaps one of the first antenna structure or the second antenna structure. An antenna module having two additional antenna structures is disclosed. Methods of enhancing coupling are disclosed.

US 20130075477 (Finn, Ummenhofer; 2013) discloses improving coupling in and to RFID smart cards. A data carrier such as a smart card comprising an antenna module (AM) and a booster antenna (BA). The booster antenna (BA) has an outer winding (OW) and an inner winding (IW), each of which has an inner end (IE) and an outer end (OE). A coupler coil (CC) is provided, connecting the outer end (OE, b) of the outer winding (OW) and the inner end (IE, e) of the inner winding (IW). The inner end (IE, a) of the outer winding (OW) and the outer end (OE, f) of the inner winding (IW) are left un-connected (free floating). The coupler coil (CC) may have a clockwise (CW) or counter-clockwise (CCW) sense which is the same as or opposite to the sense (CW or CCW) of the outer and inner windings. Various configurations of booster antennas (BA) are disclosed.

U.S. Pat. No. 8,393,547 (Kiekhafer; Perfect Plastic; 2013), discloses RF Proximity Financial Transaction Card Having Metallic Foil Layer(s). A contactless financial transaction card includes a plastic inlay having first and second substantially planar surfaces bounded by a continuous peripheral edge. An integrated circuit carried by the inlay stores card-specific data. An antenna carried by the inlay is operatively connected to the integrated circuit. The foil layer provides the financial transaction card with a decorative metallic reflective appearance and is constructed to permit the antenna to inductively couple with the card reader within the maximum coupling distance. Printed graphics or text may be disposed on or above the metallic foil layer. The card is constructed to inductively couple with a card reader that is spaced from the card in order to support limited-range wireless communication between the card and the card reader up to a maximum coupling distance, beyond which it will not couple. Claim 1 thereof is directed to . . . .
1. An RF proximity financial transaction card, comprising:
   a plastic inlay having first and second substantially planar surfaces bounded by a continuous peripheral edge;
   an integrated circuit carried by said inlay storing card-specific data;
   an antenna carried by said inlay that is operatively connected to said integrated circuit;
   a metallic foil layer having a peripheral edge that is substantially coextensive with said continuous peripheral edge of said plastic inlay, said metallic foil layer substantially overlying at least one of said substantially planar surfaces such that said metallic foil layer provides said financial transaction card with a decorative metallic reflective appearance across one or both of a front or rear face of said card;
   printed graphics or text on or above said metallic foil layer; and said card being constructed to inductively couple with an RF proximity card reader that is spaced from said card in order to support limited-range wireless communication between the card and the card reader up to a maximum coupling distance, beyond which said card will not couple.

### SUMMARY

It is a general object of the invention to provide improved techniques for improving coupling with RFID smart cards (as an example of secure documents, and the like). It is a further general object of the invention to provide an improved booster antenna BA for smart cards. The booster antenna BA may comprise a card antenna CA component, a coupler coil (or coupler antenna) CC component, and an extension antenna (or extension coil) EA component.

Various embodiments will be described to illustrate teachings of the invention(s), and should be construed as illustrative rather than limiting. Any dimensions and materials or processes set forth herein should be considered to be approximate and exemplary, unless otherwise indicated.

A metallized layer (ML) may be included in a dual interface smart card.

A card body CB may comprise:
a surface having a surface area, an upper portion of the surface constituting approximately half of the surface area of the card body and a lower portion of the surface constituting a remaining approximately half of the surface area of the card body;
a first area for extending around a peripheral portion of the card body in at least the upper portion of the card body;
a card antenna CA disposed in the first area;
a second area located in the upper portion of the card body and corresponding in size to an antenna module AM;
a third area located in the upper portion of the card body which is separate from the first area and the second area; and
an extension antenna EA disposed in the third area.

A coupler coil CC may be disposed in the second area. A portion of the extension antenna EA may be disposed adjacent at least 90° of the coupler coil CC. The coupler coil CC may have two ends, and may be formed as a closed loop or as an open loop.

The extension antenna EA may contribute to the inductance of the booster antenna BA. The extension antenna EA may have two ends—one end may be connected to the coupler coil CC, the other end may be connected to the card antenna CA.

Other embodiments may be disclosed. Some interim products may be disclosed, and may be claimed.

The invention(s) described herein may relate to industrial and commercial industries, such RFID devices and applications, smartcards, electronic passports and the like.

Other objects, features and advantages of the invention(s) disclosed herein may become apparent in light of the following illustrations and descriptions thereof.

### DRAWINGS

Reference will be made in detail to embodiments of the disclosure, non-limiting examples of which may be illustrated in the accompanying drawing figures (FIGs). The figures may generally be in the form of diagrams. Some elements in the figures may be exaggerated or drawn not-to-scale, others may be omitted, for illustrative clarity. Some figures may be in the form of diagrams.

When terms such as “left” and “right”, “top” and “bottom”, “upper” and “lower”, “inner” and “outer”, or similar terms are used in the description, they may be used to guide the reader to orientations of elements in the figures, but should be understood not to limit the apparatus being described to any particular configuration or orientation, unless otherwise specified or evident from context.

Different “versions” or iterations of elements may be referenced by reference numerals having the same numbers (###) followed by a different letter suffix (such as “A”, “B”, “C”, or the like), in which case the similar elements may be inclusively referred to by the numeric portion (###) only of the reference numeral. Similar elements in different drawings may be referred to by similar numbers, differing in their most significant (typically hundreds) digit. Some elements may be referred to with letters (e.g., “BA”, “CA”, “CC”, “EA” and the like), rather than (or in addition to) numerals (e.g., “12”). Any text (legends, notes, reference numerals and the like) appearing on the drawings are incorporated by reference herein.

Although the invention may be illustrated in the context of various exemplary embodiments, it should be understood that it is not intended to limit the invention to these particular embodiments, and individual features of various embodiments may be combined with one another.

FIG. 1 is a cross-section of a dual-interface smart card and readers.

FIG. 1A is a top view of a card body (CB) for the smart card of FIG. 1.

FIG. 2 is a diagram of an embodiment of a booster antenna (BA) having a card antenna (CA) with an inner winding (IW) and an outer winding (OW), and a coupler coil (CC).

FIG. 2A is a diagram illustrating an arrangement of a coupler coil (CC) in relation to a card antenna (CA).

FIG. 3A is a diagram illustrating a card antenna (CA), coupler coil (CC) and extension antenna (EA) components of a booster antenna (BA).

FIG. 3B is a diagram illustrating various areas of a card body CB of a smart card.

FIG. 4 is a diagram illustrating some antenna components, at least one of which is a “true” coil having a cross-over.

FIG. 4A is a diagram illustrating of a booster antenna (BA) with card antenna CA, a coupler antenna (CC) and an extension antenna (EA).

FIGS. 5A, 5B, 5C are diagrams (plan views), each showing a configuration of a coupler coil (CC).

FIGS. 5D, 5E, 5F, 5G, 5H, 5I, 5J are diagrams (plan views), each showing a configuration of booster antenna (BA), and various arrangements of its components (CA, CC, EA).

FIG. 6 is a cross-sectional view, illustrating a secure document (such as a passport cover) having ferrite in the inlay substrate (or card body).

FIG. 6A is a partial diagrammatic perspective view of a smartcard with metallization.

FIG. 6B shows a compensating loop (CL) with a gap.

FIG. 6C shows a compensating loop (CL) without a gap.

FIGS. 6D, 6E, 6F, 6G are illustrations of including a metal foil (MF) in the card body (CB).

FIG. 7A is an illustration showing coupling between a reader and a transponder (such as a smart card) having a card body.

FIG. 7B is an illustration showing coupling between a reader and a module antenna (MA) of an antenna module (AM).

### DESCRIPTION

Various embodiments will be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment may be included in at least one embodiment of the present invention.

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein. Furthermore, some well-known steps or components may be described only generally, or even omitted, for the sake of illustrative clarity.

Headings (typically underlined) may be provided as an aid to the reader, and should not be construed as limiting. Any dimensions and materials or processes set forth herein should be considered to be approximate and exemplary, unless otherwise indicated.

Reference may be made to disclosures of prior patents, publications and applications. Some text and drawings from those sources may be presented herein, but may be modified, edited or commented to blend more smoothly with the disclosure of the present application.

In the main hereinafter, RFID cards, electronic tags and secure documents in the form of pure contactless cards, dual interface cards, phone tags, electronic passports, national identity cards and electronic driver licenses may be discussed as exemplary of various features and embodiments of the invention(s) disclosed herein. As will be evident, many features and embodiments may be applicable to (readily incorporated in) other forms of smartcards, such as EMV payment cards, metal composite cards, metal hybrid cards, metal foil cards, access control cards and secure credential documents. As used herein, any one of the terms “transponder”, “tag”, “smartcard”, “data carrier” and the like, may be interpreted to refer to any other of the devices similar thereto which operate under ISO 14443 or similar RFID standard. The following standards are incorporated in their entirety by reference herein:
ISO/IEC 14443 (Identification cards—Contactless integrated circuit cards—Proximity cards) is an international standard that defines proximity cards used for identification, and the transmission protocols for communicating with it.
IS O/IEC 7816 is an international standard related to electronic identification cards with contacts, especially smartcards.
EMV standards define the interaction at the physical, electrical, data and application levels between IC cards and IC card processing devices for financial transactions. There are standards based on ISO/IEC 7816 for contact cards, and standards based on ISO/IEC 14443 for contactless cards.

A typical data carrier described herein may comprise
(i) an antenna module (AM) having an RFID chip (CM; or chip module) and a module antenna (MA),
(ii) a card body (CB) and
(iii) a booster antenna (BA) with coupler coil (CC) disposed on the card body (CB) to enhance coupling between the module antenna (MA) and the antenna of an external RFID “reader”.

When “chip module” is referred to herein, it should be taken to include “chip”, and vice versa, unless explicitly otherwise stated. Chip or chip module may be referred to as “CM”. Throughout the various embodiments disclosed herein, unless specifically noted otherwise (in other words, unless excluded), the element referred to as “CM” will most appropriately be a bare integrated circuit (IC) die (or RFID chip), rather than a chip module (a die with a carrier). In contrast therewith, some figures present examples that are specifically “chip modules” having IC chips (such as a “CM”) mounted and connected to substrates. A “chip module” (die and carrier) with a module antenna (MA) mounted and connected thereto may be referred to as an antenna module (AM).

The module antenna (MA) may comprise a coil of wire, conductive traces etched or printed on a module tape (MT) or antenna substrate (AS) for the antenna module (AM), or may be incorporated directly on the chip itself.

The descriptions that follow are mostly in the context of dual interface (DI, DIF) smartcards, and relate mostly to the contactless operation thereof. Many of the teachings set forth herein may be applicable to electronic passports and the like having only a contactless mode of operation (single interface). Generally, any dimensions set forth herein are approximate, and any materials set forth herein are intended to be exemplary, not limiting.

### RFID Cards, Generally

For the purpose of discussion, an RFID (radio frequency identification) card, which may be referred variously as an integrated circuit card (IC card or “chip card”) or secure document, generally comprises an RFID chip (CM) implanted in or disposed on a substrate and a card antenna (CA) disposed in or on a substrate, may operate on the principle of inductive coupling with no physical electrical connections between the chip module (CM) and the card antenna (CA), and may form the basis of a secure document such as an electronic passport, national identity card, contactless smartcard, contact/contactless smartcard, chip card, electronic EMV (Europay, MasterCard and Visa) payment card, electronic driver's license, electronic health card or electronic tag, which may also be referred to as a data carrier with contactless functionality.

An RFID silicon die packaged in a suitable housing may be referred to as a chip module (CM). The chip module in its broadest sense also encompasses an integrated circuit (IC), a bare silicon die, a stud-bumped chip, a straight wall bumped chip or a coil on chip device.

The chip module (CM) may be a lead-frame-type chip module, an epoxy-glass type chip module or a flexible PET chip module. The RFID silicon or organic die may be mounted to the chip carrier tape or module tape (MT) forming the chip module (CM) by means of die & wire bonding or flip chip assembly. The chip carrier tape can be metallized on one side (contact side) or on both sides with through-hole plating to facilitate the interconnection with the antenna. The chip carrier tape may also incorporate a chemically etched antenna, printed antenna or nanostructured antenna.

The substrate, which may be referred to as an “inlay substrate” (such as for an electronic passport) or “card body” (such as for a smartcard) may comprise one or more layers of material such as Polyvinyl Chloride (PVC), Polycarbonate (PC), Polyethylene (PE), Poly(ethylene terephthalate) (PET), Polyetherurethane, PET-G (Polyethylene Terephtalate Glycol-modified), Polyester Copolymer film, Teslin™, paper, synthetic paper and the like.

The combination of RFID chip (CM) and card antenna (CA) may operate solely in a contactless (non-contact) mode (such as ISO 14443), or may be a dual interface (DI, DIF) chip module (CM) which may additionally be operative to function in a contact mode (such as ISO 7816-2) and a contactless mode. The RFID chip (CM) may harvest energy from an RF signal supplied by an external RFID reader device with which it communicates.

The chip module (CM) may also be referred to as an antenna module (AM) incorporating a chip carrier tape or module tape (MT), an RFID die mounted to the module tape (MT) by means of die & wire bonding or flip chip assembly, and a module antenna (MA). In most cases, the RFID die is referred to as the chip or chip module forming part of the antenna module.

Throughout the various embodiments disclosed herein, unless specifically noted otherwise (in other words, unless excluded), the element referred to as “CM” will most appropriately be a bare integrated circuit (IC) die (or RFID chip), rather than a chip module (a die with a carrier). In contrast therewith, some figures present examples that are specifically “chip modules” having IC chips (such as a “CM”) mounted and connected to substrates. A “chip module” (die and carrier) with a module antenna (MA) mounted and connected thereto may be referred to as an antenna module (AM).

The booster antenna (BA) with coupler coil (CC) may be formed by embedding wire in an inlay substrate or card body (CB). However, it should be understood that the antenna may be formed using processes other than by embedding wire in a substrate, such as additive or subtractive processes such as printed antenna structures, coil winding techniques (such as disclosed in U.S. Pat. No. 6,295,720), antenna structures formed on a separate antenna substrate and transferred to the inlay substrate (or layer thereof), antenna structures etched (including laser etching) from a conductive layer on the substrate, structured nanowire networks (including laser ablation) on the substrate, conductive material deposited on the substrate or in channels formed in the substrate, or the like. When “inlay substrate” is referred to herein, it should be taken to include “card body”, and vice versa, as well as any other substrate for a secure document, unless explicitly otherwise stated.

The descriptions that follow are mostly in the context of dual interface (DI, DIF) smart cards, and relate mostly to the contactless operation thereof. Many of the teachings set forth herein may be applicable to electronic passports and the like having only a contactless mode of operation. Generally, any dimensions set forth herein are approximate, and materials set forth herein are intended to be exemplary.

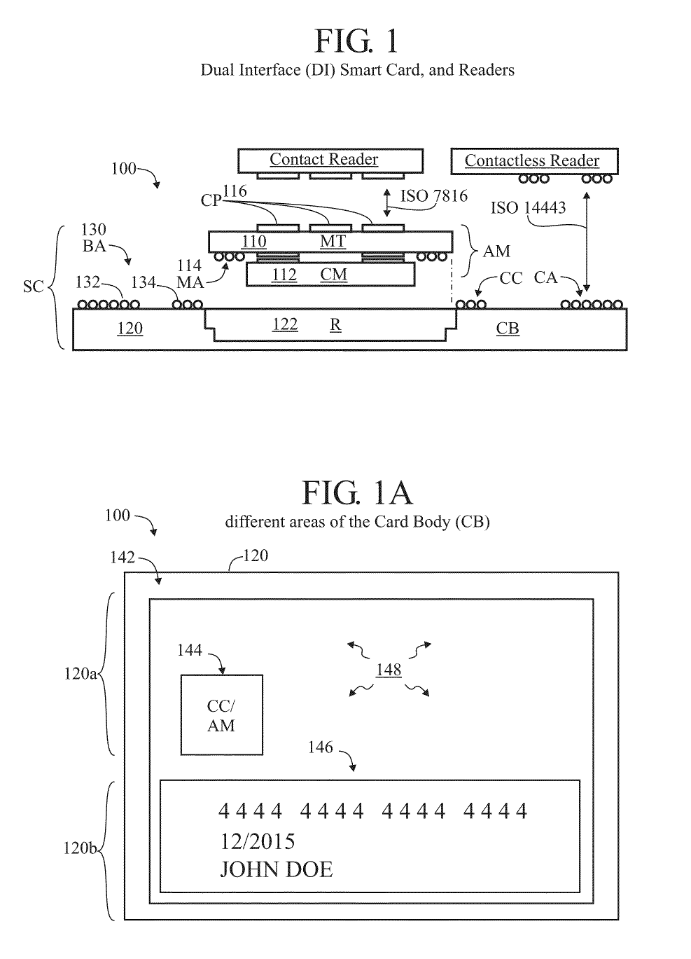

FIGS. 1 and 1A illustrate a smart card (SC) 100, along with a contact reader and a contactless reader. The antenna module AM may comprise a module tape (MT) 110, an RFID chip (CM) 112 disposed on one side of the module tape MT along with a module antenna (MA) 114 and contact pads (CP) 116 disposed on the other side of the module tape MT for interfacing with an external contact reader. The card body (CB) 120 comprises a substrate which may have a recess (R) 122 extending into one side thereof for receiving the antenna module AM. (The recess R may be stepped—such as wider at the surface of the card body CB—to accommodate the profile of the antenna module AM.) The booster antenna (BA) 130 may comprise turns (or traces) of wire (or other conductor) embedded in (or disposed on) the card body CB, and may comprise a number of components such as (i) a card antenna (CA) component 132 and (ii) a coupler coil (CC) component 134.

The card body (CB) 120 has a surface with an overall surface area, such as approximately 54 mm×86 mm˜=4600 mm². An upper portion 120a of the card body CB may constitute approximately half (such as 50-70%) of the overall surface area of the card body CB, and a lower portion 120b of the card body CB may constitute a remaining approximately half (such as 30-50%) of the overall surface area of the card body CB.

A “peripheral” area 142 of the surface of the card body CB extends around the periphery of the card body CB in at least the upper portion 120a thereof, and may have a width of up to approximately 5 mm. The card antenna CA component may be disposed in this first area. The width of the first, peripheral area 142 may be greatest at the top edge of the card body CB, of medium width at the side edges of the card body CB, and least at the bottom edge of the card body CB.

A “coupling” area 144 of the surface of the card body CB is located in an interior area (within the peripheral area 142) of the card body CB, in the upper portion 120a thereof, at a position corresponding to the location of the antenna module AM, and may be of approximately the same size as the antenna module AM, such as approximately 8.2 mm×10.8 mm for a 6-contact module and 11.8 mm×13 mm for an 8-contact module.

An “embossing” area 146 of the surface of the card body CB is located in an interior area (within the peripheral area 142) of the card body CB, in the lower portion 120b thereof, is separate from the peripheral area 142 and the coupling area 144, and may constitute most (such as 80-90%) of the lower portion 120b of the card body CB.

A “remaining” (or “residual”) area 148 of the surface of the card body CB is located in an interior area (within the peripheral area 142) of the card body CB, in the upper portion 120a thereof, is separate from the peripheral area 142 and the coupling area 144, and may constitute most (such as 60-80%) of the upper portion 120b of the card body CB. The card antenna 132 and coupler coil 134 are not disposed in this remaining area 148—in other words, are disposed substantially entirely in areas (142, 144) other than the remaining area 148 (and other than the embossing area 146).

As described in greater detail hereinbelow, according to an aspect of the invention, generally, an additional booster antenna component, referred to herein as an antenna extension (EA) component, may be disposed in remaining (or residual) area 148 of the surface of the card body CB. The antenna extension EA may comprise several turns (or traces) of wire (or other conductive material), and may be either (i) connected with one or both of the card antenna CA and coupler coil CC or (ii) not connected with either of the card antenna CA and coupler coil CC.

It is generally not desirable, but nevertheless possible that some of the booster antenna BA components, particularly at least a portion of the card antenna CA and a portion of the extension antenna EA may extend into the embossing area (146). In such a scenario, flat ribbon wire may be used. A wire for the booster antenna BA may be pre-flattened in an area which will correspond to where the wire will be disposed in the embossing area (146).

### An Example of a Booster Antenna (BA)

The aforementioned US 20130075477 discloses a booster antenna BA arrangement (configuration) for a smart card. The booster antenna BA generally comprises a card antenna CA and a coupler coil.

A card antenna CA may comprise a single wire (or conductive trace) having two ends, arranged in a generally a rectangular spiral pattern, and disposed in the peripheral area (see 142, FIG. 1A) of the card body CB. The card antenna CA may comprise different portions, such as disclosed in U.S. Pat. No. 8,130,166 (Assa Abloy; 2012). The card antenna CA may comprise two distinct windings, such as an inner winding IW and an outer winding OW. A coupler coil CC may or may not be associated with the card antenna CA. The card antenna CA and coupler coil CC may constitute two components of a booster antenna BA.

According to an aspect of the invention, a component, referred to herein as an antenna extension EA may be associated with the booster antenna BA, and may be used with any suitable configuration of card antenna CA and coupler coil CC.

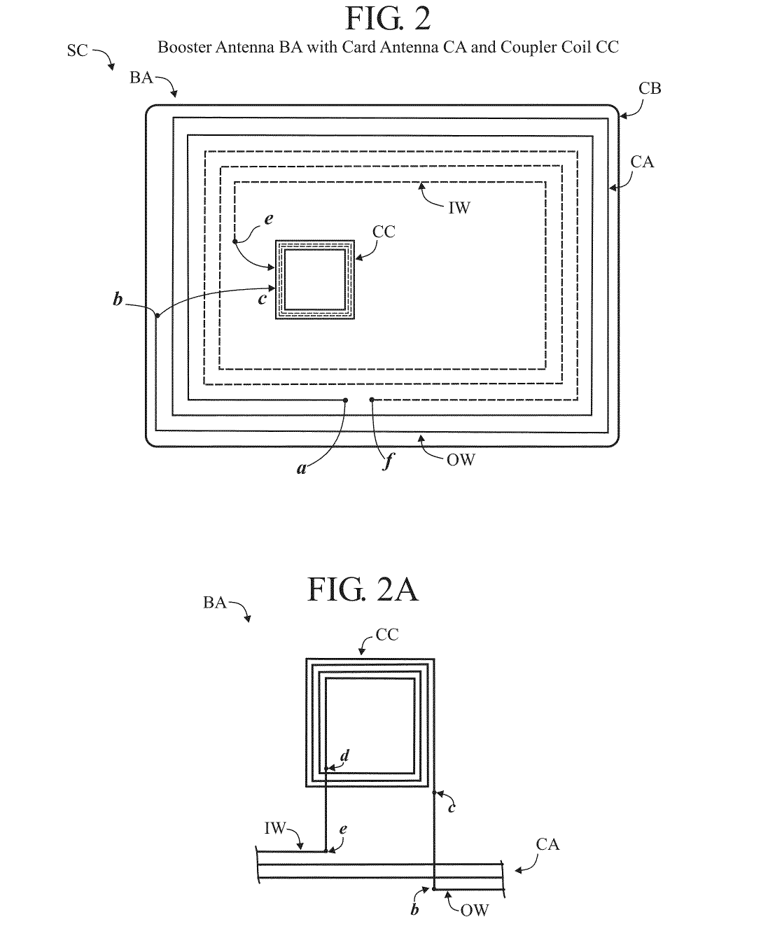

FIG. 2 shows a booster antenna BA comprising a card antenna CA component extending around the peripheral area (142) of a card body CB, and having two windings—an outer winding OW and an inner winding IW, both extending substantially around the peripheral area (142) of the card body CB. Additionally, a coupler coil CC is shown which may be disposed in the coupling area (144).

The booster antenna BA may be formed using insulated, discrete copper wire disposed (such as ultrasonically bonded) around (inside of) the perimeter (periphery) of a card body CB (or inlay substrate, or data carrier substrate, such as formed of thermoplastic). The booster antenna BA comprises an outer winding OW (or coil, D) and an inner winding IW (or coil, D), and further comprises a coupler coil CC, all of which, although “ends” of these various coil elements are described, may be formed from one continuous length of wire (such as 80 μm self-bonding wire) which may be laid upon or embedded in the card body CB. More particularly,

The outer winding OW may be a long wire (or conductive trace) wire having two ends—an inner end “a” and an outer end “b”—mounted to the card body CB in the form of a rectangular spiral having a number of (at least one) turns, and may be disposed in the peripheral area (142) of the card body CB.

The outer winding OW (compare D, FIG. 1A) may be formed as a spiral having a number (such as 2-3) of turns and having an inner end IE at point “a” and an outer end OE at point “b”. The outer winding OW is near (substantially at) the periphery (perimeter) of the card body CB. The inner end IE (“a”) of the outer winding OW is a free end.

The dimensions of the card body CB may be approximately 54 mm×86 mm. The outer dimension of the outer winding OW of the booster antenna BA may be approximately 80×50 mm. The wire for forming the booster antenna BA may having a diameter (d) of approximately 100 μm (including, but not limited to 80 mm, 112 μm, 125 μm).

The inner winding IW may be a long wire (or conductive trace) having two ends—an inner end “e” and an outer end “f”—mounted to the card body in the form of a rectangular spiral having a number (at least one) of turns, and may be disposed in the peripheral area (142) of the card body CB. The inner winding IW may be disposed within (towards the interior of the card body CB) the outer winding OW.

The outer end “b” of the outer winding OW may be connected with the inner end “e” of the inner winding IW, either directly (not shown, see FIG. 2A of U.S. Ser. No. 13/600,140) or via the intermediary of a coupler coil CC.

The inner end IE (a) of the outer winding OW and the outer end OE (f) of the inner winding IW may be left unconnected, as “free ends”.

The overall booster antenna BA comprising outer winding OW, coupler coil CC and inner winding IE is an open circuit, and may be referred to as a “quasi-dipole”—the outer winding OW constituting one pole of the dipole, the inner winding IW constituting the other pole of the dipole—center fed by the coupler coil CC.

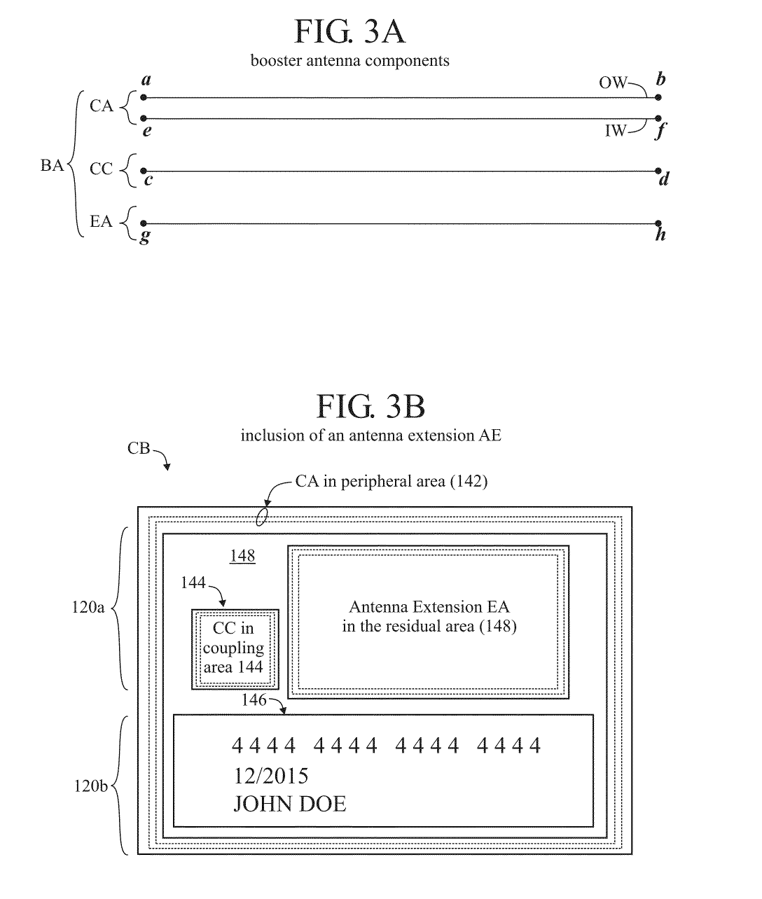

The coupler coil CC may be a long wire (or conductive trace) or conductive trace having two ends “c” and “d”. The aforementioned U.S. Ser. No. 13/600,140 (US 20130075477), incorporated by reference herein discloses various configurations for laying and connecting the inner winding IW, outer winding OW and coupler coil CC. See, for example, FIGS. 3A-3D therein. The present invention is not limited to any particular one(s) of these configurations.

The coupler coil CC may be formed as a spiral having a number (such as approximately 10) of turns and having two ends “c” and “d”. The end “c” may be an outer end OE or an inner end IE, the end “d” may be an inner end IE or an outer end OE, as described with respect to the embodiments shown in FIGS. 3A, 3B, 3C, 3D of US 20130075477. The coupler coil CC is disposed at an interior portion of the card body CB, away from the periphery, and is shown only generally with a few dashed lines in FIG. 2.

It should be understood that the booster antenna BA could be made with other than wire using additive processes such as printing conductive material onto the substrate CB, or subtractive processes such as etching conductive material away from the substrate CB. For such non-wire antennas, although there may be no actual direction such as is inherent with laying or embedding the wire (the course of laying the wire, from one end to the other), but the resulting spiral elements OW, IW, CC of the booster antenna BA may nevertheless exhibit a clockwise CW or counter-clockwise CCW “virtual sense” (or orientation) which can be determined by analogy to laying wire. (For an additive process such as inkjet printing, which is sequential, the sense would be actual.) The “sense” can be determined by following the pattern from “a” to “f”, or from “f” to “a”.

As used herein, “pitch” may refer to the average distance, center-to-center (c-c), between adjacent turns of a wire for a winding (OW, IW) or the coupler coil (CC), as it is being laid. (Or, by analogy, to the center-to-center distance between adjacent conductive tracks made by additive or subtractive processes). It should be understood that during manufacturing (including as a result of subsequent manufacturing steps such as laminating), the pitch of the wire may vary or change somewhat, such as +/−5%, or more. And, when going around a corner, such as in a rectangular spiral, the pitch may be somewhat indeterminate. It should also be understood that the pitch of the windings (OW, IW) or coupler coil (CC) may be advertently altered (typically increased) locally, such as at the free ends “a” and “f”, to accommodate manufacturing processes (such as starting and ending embedding the wire) and the like. “Pitch” may refer to the initial (during laying) or final (after laminating) distance (c-c) between adjacent turns of a winding.

The outer winding OW, coupler coil CC and inner winding IW may be formed as one continuous structure, using conventional wire embedding techniques. It should be understood that references to the coupler coil CC being connected to ends of the outer winding (OW) and inner winding (IW) should not be construed to imply that coupler coil CC is a separate entity having ends. Rather, in the context of forming one continuous structure of outer winding OW, coupler coil CC and inner winding IW, “ends” may be interpreted to mean positions corresponding to what otherwise would be actual ends—the term “connected to” being interpreted as “contiguous with” in this context.

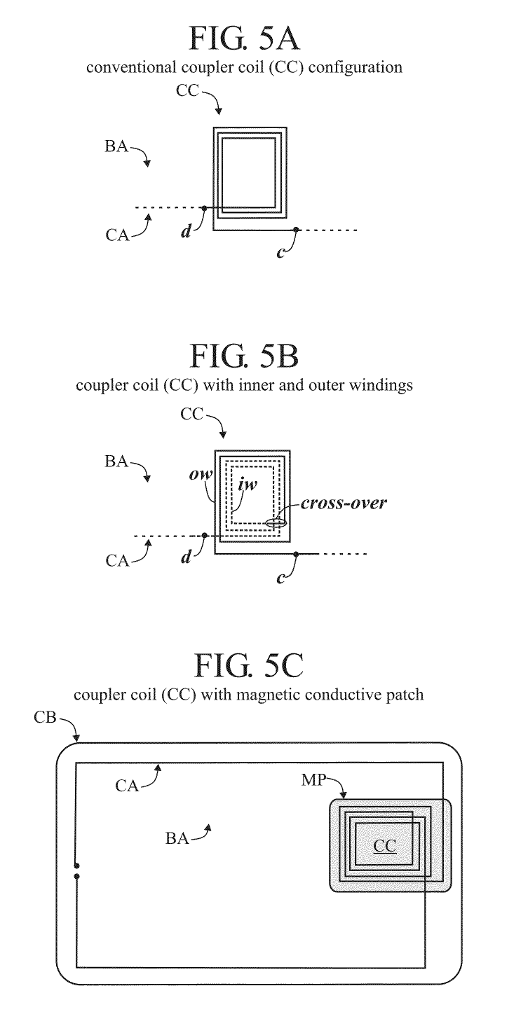

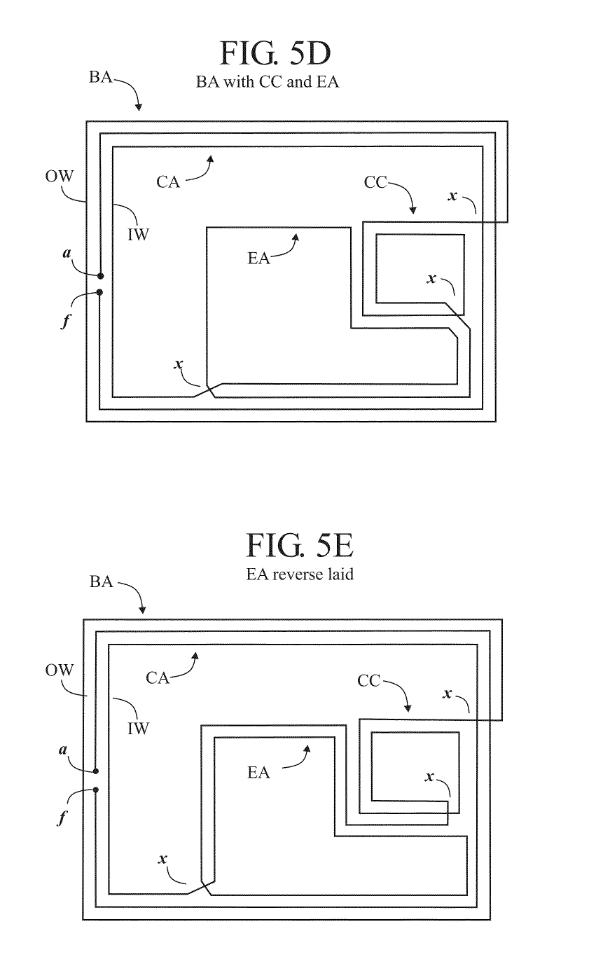

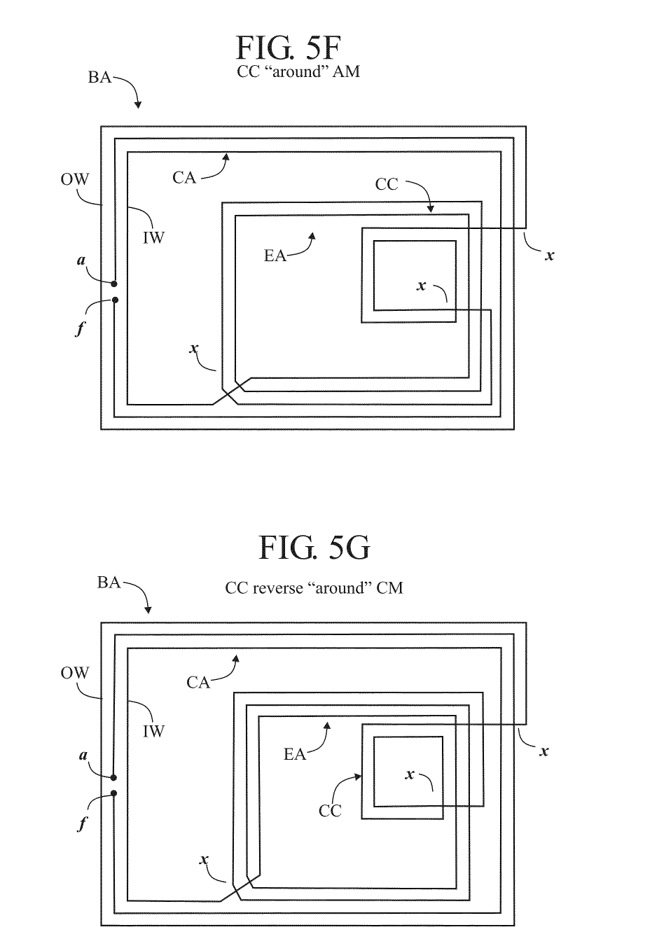

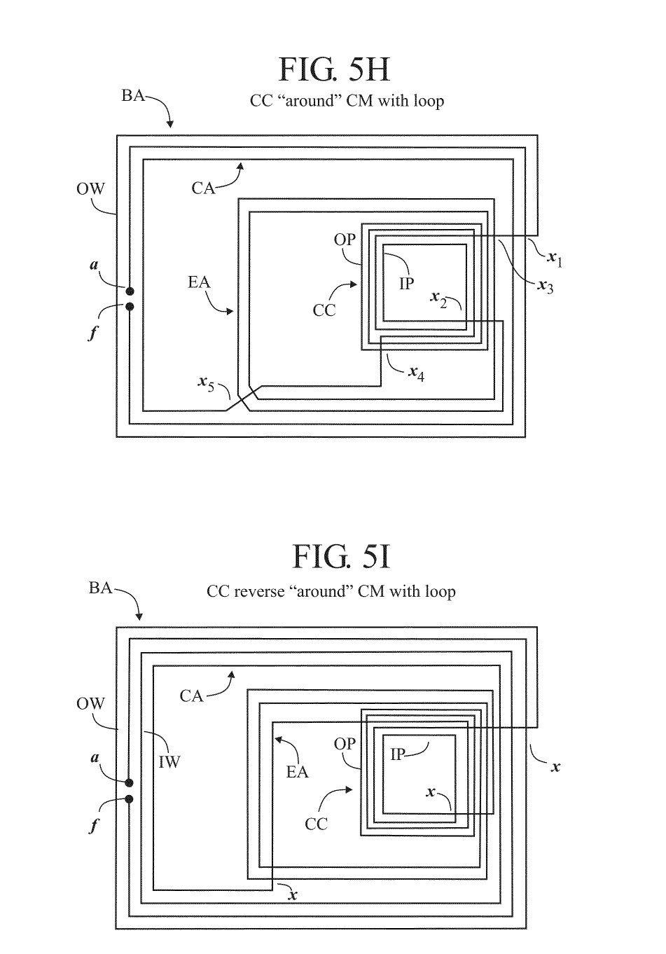

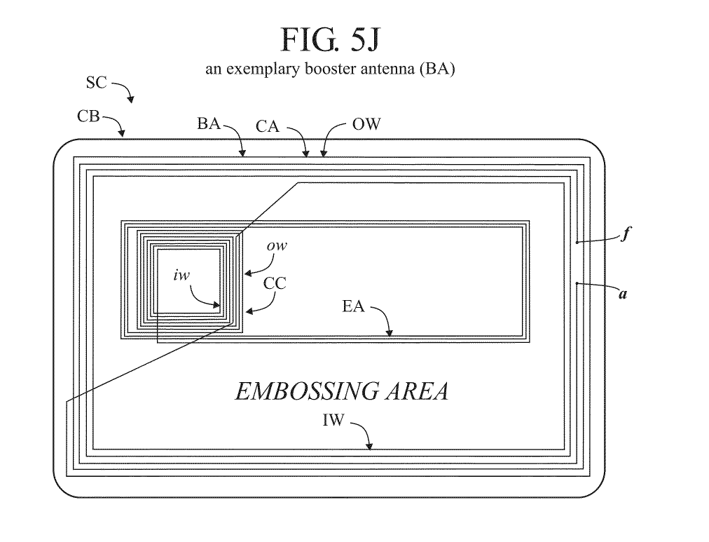

The inner winding IW may be disposed within the outer winding OW, as illustrated, on a given surface of the card body CB (or layer of a multi-layer inlay substrate). Alternatively, these two windings of the booster antenna BA may be disposed on opposite surfaces of the card body CB or on two different layers of the card body CB (see FIGS. 5F, 5G), substantially aligned with one another (in which case they would be “top” and “bottom” windings rather than “outer” and “inner” windings. The two windings of the booster antenna BA may be coupled in close proximity so that voltages induced in them may have opposite phase from one another. The coupler coil CC may be on the same surface of the card body CB as the outer and inner windings.

The turns of the outer winding OW and inner winding IW of the booster antenna BA may be at a pitch of 0.2 mm (200 μm), resulting in a space of approximately one wire diameter between adjacent turns of the outer winding OW or inner winding IW. The pitch of the turns of the coupler coil CC may be substantially the same as or less than (stated otherwise, not greater than) the pitch of turns of at least one of the outer winding OW and inner winding IW—for example 0.15 mm (150 μm), resulting in space smaller than one wire diameter between adjacent turns of the coupler coil (CC). Self-bonding copper wire may be used for the booster antenna BA. The pitch of both the outer/inner windings OW/IW and the coupler coil CC may both be approximately 2× (twice) the diameter of the wire (or width of the conductive traces or tracks), resulting in a spacing between adjacent turns of the spiral(s) on the order of 1 wire diameter (or trace width). The pitches of the outer winding OW and the inner winding IW may be substantially the same as one another, or they may be different than each other. The outer winding OW and inner winding IW may have the same sense (clockwise CW or counter-clockwise CCW) as each other.

It is within the scope of the invention that more turns of wire for the coupler coil CC can be accommodated in a given area—for example, by laying two “courses” of wire, one atop the other (with an insulating film therebetween, if necessary), in a laser-ablated trench defining the area for the turns of the coupler coil CC.

In FIG. 2, the coupler coil CC is shown without detail, represented by a few dashed lines. Some details of its construction, and how is my be connected with the outer winding OW and inner winding IW are set forth in FIGS. 3A-3D.

FIG. 2A shows one example of a coupler coil CC which is laid by starting at a point “c”, laying the coupler coil CC from outer turn to inner turn, in a counter-clockwise direction. When the inner winding is complete (point “d”), the wire crosses-over the already laid turns. Other alternatives are starting at the an inner winding and continuing outward, and winding in different direction, winding the coupler coil CC in the same or opposite directions (sense) as the card antenna CA.

An antenna module AM may be mounted in on the card body CB so that its module antenna MA is closely adjacent the coupler coil CC, for coupling therewith. The antenna module AM may be disposed with its module antenna MA overlapping the coupler coil CC, or with its module antenna completely within the interior of the coupler coil CC, or with entirely within the coupler coil CC. The antenna module AM may be installed in a milled cavity on the card body CB so that its module antenna MA may be substantially coplanar with the coupler coil CC. The module antenna MA may be at a different level than (not coplanar with) the coupler coil CC.

The module antenna MA for the antenna module AM may also be a coil of wire wound with either a clockwise (CW) or counter-clockwise (CCW) sense. The module antenna MA may have the same sense (CW, or CCW) as the coupler coil CC. The module antenna MA may have the opposite sense (CW, or CCW) as the coupler coil CC. The module antenna MA may have the same sense (CW, or CCW) as the outer winding OW and/or the inner winding IW. The module antenna MA may have the opposite sense (CW, or CCW) as the outer winding OW and inner winding IW.

It may be noted that NL 9100347 (NEDAP; 1992) and U.S. Pat. No. 5,955,723 (Siemens; 1999) both describe 2 coils that are of a “given dimension”. For example Coils 1 & 3—Coil 1 on the chip and Coil 3 on the card—and they also say they are concentric to each other and that allows the coupling. In the arrangements described herein, the coils (MA, CC) are not restricted to being the same size, nor are they restricted to being concentrically positioned.

In the course of laying the wire (or otherwise creating conductive paths for the antenna elements OW, CC, IW, using any of a variety of additive or subtractive processes) for the booster antenna BA, it is evident that the wire (or conductive path) may need to cross over itself at several positions. For a booster antenna BA comprising wire, the wire may be insulated, typically self-bonding wire. For conductive paths, appropriate insulating or passivation layers or films may be used to facilitate cross-overs.

### Booster Antenna (BA) Components and Placement on the Card Body (CB)

FIG. 3A shows, schematically, some components of an exemplary booster antenna (BA)-namely:
an exemplary card antenna CA may comprise a first winding OW having two ends “a” and “b” and a second winding IW having two ends “e” and “f”, such as may have been described above.
an exemplary coupler coil CC may have two ends “c” and “d”, such as may have been described above
the card antenna CA and coupler coil CC may be connected with one another in any suitable manner, such as may have been described above
an antenna extension AE may be a long wire (or conductive trace) wire having two ends “g” and “h”—mounted to the card body CB in any suitable form such as (but not limited to) a spiral having a number of (at least one) turns, and may be disposed in the residual area (see 148, FIG. 1A) of the card body CB.
the booster antenna BA components CA (OW, IW), CC and AE are illustrated as straight line segments, the dots at their two ends simply indicating an end position of the wire (or conductive trace), being included for graphic clarity.

FIG. 3B expands upon FIG. 1A and illustrates, schematically and generally, the addition (inclusion) of an extension antenna EA component of a booster antenna BA disposed in the residual area (148) of a smart card. The extension antenna EA is shown only generally in this figure, it is shown in greater detail in other figures.

Some Configurations of Booster Antennas BA with Extension Antennas EA

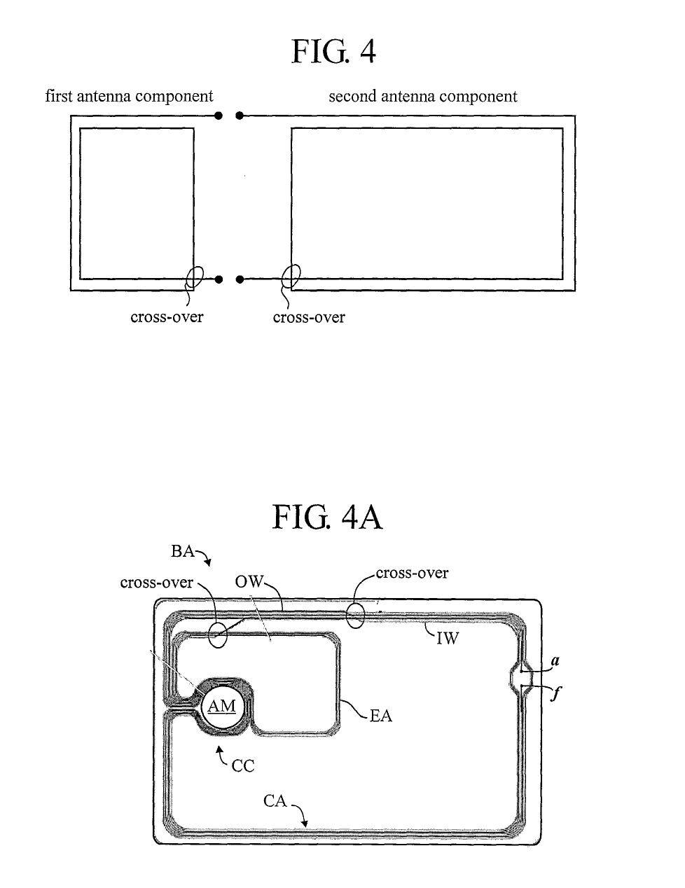

Some configurations of booster antennas BA comprise card antennas CA which may be one winding or two windings (such as inner winding IW and outer winding OW), coupler coils CC (or coupler antennas) and extension antennas EA (or antenna extension, or extension coil, or extension loop). Each of the (CA, OW, IW, CC, EA) booster antenna components typically has two ends (see FIG. 3A), and typically has a plurality of windings (or turns). Both of the ends of a given antenna component may be connected to ends of other antenna components. Alternatively, one of the two ends of an antenna component may be a free end. Some of these components may be in the form of an open loop coil or a closed coil. An antenna component in the form of a “true” coil will exhibit a cross-over (see FIG. 4).

FIG. 4 is a diagram illustrating schematically some antenna components of a booster antenna (BA), at least one of which is a “true” coil having a cross-over. Generally, geometrically speaking, if a coil has at least one complete 360° turn, and is connected to another component that is disposed either outside of or inside of the coil—and there are no vias through the substrate (card body CB) for making connections from inside the coil to the outside thereof—it is inherently necessary that the pattern of the coil cross-over itself so that the two ends of the coil can connect with two terminals of the other component, as shown. In this figure, both of the components are true-coils. As used herein, a “true” coil may be defined as a coil, loop or spiral of wire (or other conductor) having two ends (such as “g” and “h”), extending at least approximately 360°, substantially enclosing an area (such as the coupling area 144), and crossing over itself (either from the outside in, or from the inside out).

U.S. 61/697,825 filed 7 Sep. 2012 discloses a booster antenna BA comprising an inner winding IW and an outer winding OW (as disclosed herein, together the inner winding IW and outer winding OW may constitute a card antenna CA), an “open loop” coupler coil CC at the position of the antenna module AM, and an “extension” which may be referred to herein as an “antenna extension” or “extension antenna” or “extension coil” EA. See also U.S. Ser. No. 13/600,140 filed 30 Aug. 2012 (now US 20130075477 published Mar. 28, 2013.

FIG. 4A is a diagram corresponding to FIG. 5H of U.S. Ser. No. 13/600,140 (US 20130075477), showing a booster antenna (BA) having a card antenna CA, a coupler coil CC and an extension antenna (EA). These components may be formed (embedded in the card body CB) as one continuous embedded coil. The coupler coil CC is in the form of an open loop (“horseshoe”).

Note that both of the outer winding OW and inner winding IW are enlarged to form the coupler coil CC and substantially fully encircle the antenna module AM in the coupling area (144). The free ends (a, 0 of the card antenna CA are shown disposed at the right edge of the card body CB.

The extension antenna EA has one end extending from an end of the coupler coil CC, and another end extending from an end of the card antenna CA, and exhibits a cross-over. The extension antenna EA (or extension coil, or extension loop) is disposed so as to have a portion adjacent two sides (or approximately 180°) of the coupler coil CC.

An antenna extension EA component is shown as an “extension” of the inner winding IW, comprising some turns of wire in a spiral pattern disposed near the antenna module AM in the left hand side of the top (as viewed) portion (120a) of the card body CB. The extension antenna EA may be disposed outside of, but near the coupling area (144) of the card body CB, in the residual area (148).

In this example, the coupler coil CC component of the booster antenna BA does not need to be a “true” coil, it does not need to have a cross-over. Rather, it may be a horseshoe-shaped “open” loop which substantially fully, but less than 360°, encircles the coupling area (144) for inductive coupling with the module antenna MA of the antenna module AM.

In this example, the card antenna CA is a true coil, in the form of a spiral extending around the peripheral area (142) of the card body CB, and exhibits a cross-over.

The extension antenna (or extension coil) EA has two ends—one end is connected to the coupler coil CC, the other end is connected to the card antenna CA. The extension antenna EA may be formed as a spiral of wire embedded in the card body CB, contiguous with one or more of the card antenna CA and coupler coil CC, and is a true coil which exhibits a cross-over, and contributes to the inductive coupling of the booster antenna BA. The extension antenna EA may be disposed in the residual area (148) of the card body CB, and is shown as being disposed only in the upper half (120a) of the card body CB, but it may extend to the lower half (120b) of the card body CB, including any or all of adjacent to, above, below or into the embossing area (146).

A benefit of having the extension antenna EA in a booster antenna BA may be to increase the inductivity of the booster antenna BA while reducing its resonance frequency. For example, without the extension antenna EA, the card antenna CA may require significantly more windings (such as in excess of 15 windings, instead of only 7 or 8 windings), depending on the spacing between the windings and the diameter or cross sectional area of the conductor of the wire used to form the booster antenna BA. It is within the scope of the invention that the card antenna CA has only one winding.

FIG. 5A, B, C are diagrams (plan views), each showing a configuration of a coupler coil (CC).

FIGS. 5D, E, F, G, H, I, J are diagrams (plan views), each showing a configuration of booster antenna (BA), and various arrangements of its components (CA, CC, EA).

FIGS. 5A, B, C are diagrams of some coupler coil (CC) configurations for a booster antenna (BA). The coupler coil CC may be configured in various ways to increase a coupling factor between the coupler coil CC component of the booster antenna BA and the module antenna MA of the antenna module AM.

FIG. 5A shows a configuration of a conventional (typical) coupler coil CC in the form of a flat coil having number (such as ten) of turns, and two ends c and d. The booster antenna BA extending around the periphery of the card body is illustrated with only one turn, for illustrative clarity. The coupler coil CC may have, for example, approximately 10 turns of wire, in a flat spiral pattern.

FIG. 5B shows a coupler coil CC having inner and outer windings. Starting at one end “d” of the coupler coil CC, an inner winding iw (or inner portion IP, shown in dashed lines) has approximately 5 turns of wire and is wound (laid) in a counter clockwise direction from outside-to-inside, then jumps over itself (over previously laid turns) at a “cross-over”, and an outer winding ow (or outer portion OP, shown in solid lines) has approximately 5 turns of wire and is wound (laid) in a counter clockwise direction from inside-to-outside, then terminates at the other end “c”. It should be understood that the coupler coil CC could be wound from “c” to “d”, rather than from “d” to “c”, and other variations may be implemented. The inner and outer windings iw and ow may have substantially the same number of turns, five each. Fewer turns are shown in the figure, for illustrative clarity.

FIG. 5C shows a magnetically conductive patch (e.g. ferrite) MP which may improve the coupling. The patch MP could e.g. be placed onto the coupling coil CC (between the module antenna MA and the coupling coil CC). Instead of using the whole area (module and coupling coil) it could also be possible to create only a ring of conductive material MP around the coupler coil which is outside of the module recess area covering the wires of the coupling coil only. The card antenna CA component of the booster antenna BA, which extends around the periphery of the card body is shown as having only one turn, for illustrative simplicity. It should be understood that the card antenna CA component may have several turns, and may include an inner winding IW and an outer winding OW (FIG. 1D).

### Some Configurations of Booster Antenna (BA) Components

FIGS. 5D-5I show various exemplary configurations of a booster antenna BA.

The booster antenna BA may comprise various antenna components, such as (but not limited to):
a card antenna CA component extending around a periphery of the card body (CB, not shown, see FIG. 1) for coupling with an external contactless reader (see FIG. 1),
   the card body CA component may comprise an outer winding OW and an inner winding IW (see FIG. 1B)
a coupling coil CC component disposed at an interior position (area) of the card body (CB), corresponding with a position for the antenna module (AM, not shown) for coupling with the module antenna (MA, not shown) of the antenna module (AM), and
an extension antenna (or extension coil) EA component.

The components CA, CC, EA of the booster antenna BA may be interconnected, as shown. The components of the booster antenna may comprise wire which is laid in a continuous path, from a starting point “a” to a finishing point “f” (or vice-versa). In some of the examples, the “sense” or laying direction (either clockwise CW, or counter clockwise CCW) of the various components may be the same, or different than (e.g., opposite from) the sense of other components. Some of the components may be “true coils” which may form a complete loop having a crossover “x” and contributing to the inductive coupling of the booster antenna BA. The overall booster antenna BA may have two or more crossovers “x”. The various components may each be shown with only a few turns, for illustrative simplicity, and are generally laid in a flat rectangular spiral pattern having a number (generally two or more) “turns”. One of the turns, or a portion thereof, may be an “innermost” turn of the booster antenna component. Another of the turns, or a portion thereof, may be an “outermost” turn of the booster antenna component.

Some characteristics and advantages of the various configurations shown in FIGS. 1H-1M may include, but are not limited to . . . .
altering the Q-factor of the booster antenna/module antenna system by altering the winding direction of one or more components (elements) making up the booster antenna BA
winding one or more turns of the coupler coil CC in the opposite direction to the majority of the turns, with no increase in DC resistance, but counter-winding may broaden the resonance curve and reduce Q-factor, and there may be no power loss as would be the case if a resistor introduced
winding one or more turns of the booster antenna BA in the opposite direction to the majority of the turns
winding one or more turns of the extension antenna EA in the opposite direction to the other extension antenna EA turns, or winding the entire extension antenna EA in the opposite direction to the inner and outer windings (IA, OW) of the booster antenna BA.

FIG. 5D shows a configuration for the booster antenna BA wherein from the starting point “a”, the wire commences being laid in a clockwise CW direction forming outer windings (OW) of the card antenna CA (from an innermost turn to an outermost turn), then crosses over “x” itself and heads towards the interior of the card body (CB) whereat the coupler coil CC may be formed with turns of wire laid in the counter clockwise CCW direction (from an outermost turn to an innermost turn), then crosses over “x” itself and heads towards the periphery of the card body (CB) for laying the extension antenna EA in a clockwise CW direction (from an outermost turn to an innermost turn), then the wire crosses over then crosses over “x” itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5E shows a configuration for the booster antenna BA wherein from the starting point “a”, the wire commences being laid in a clockwise CW direction forming outer windings (OW) of the card antenna CA (from an innermost turn to an outermost turn), then crosses over “x” itself and heads towards the interior of the card body (CB) whereat the coupler coil CC may be formed with turns of wire laid in the counter clockwise CCW direction (from an outmost turn to an innermost turn), then crosses over “x” itself and heads towards the periphery of the card body (CB) for laying the extension antenna EA in a counter clockwise CCW direction (from an outermost turn to an innermost turn), then the wire crosses over then crosses over “x” itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5F shows a configuration for the booster antenna BA wherein from the starting point “a”, the wire commences being laid in a clockwise CW direction forming outer windings (OW) of the card antenna CA (from an innermost turn to an outermost turn), then crosses over “x” itself and heads towards the interior of the card body (CB) whereat the coupler coil CC may be formed with turns of wire laid in the counter clockwise CCW direction (from an outermost turn to an innermost turn), then the wire crosses over “x” itself and heads towards the periphery of the card body (CB) for laying the extension antenna EA in a clockwise CW direction (from an outermost turn to an innermost turn), then the wire crosses over “x” itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5G shows a configuration for the booster antenna BA wherein from the starting point “a”, the wire commences being laid in a clockwise CW direction forming outer windings (OW) of the card antenna CA (from an innermost turn to an outermost turn), then crosses over “x” itself and heads towards the interior of the card body (CB) whereat the coupler coil CC may be formed with turns of wire laid in the counter clockwise CCW direction (from an outermost turn to an innermost turn), then the wire crosses over “x” itself and heads towards the periphery of the card body (CB) for laying the extension antenna EA in a counter clockwise CCW direction (from an outermost turn to an innermost turn), then the wire crosses over “x” itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5H shows a configuration for the booster antenna BA wherein from the starting point “a”, the wire commences being laid in a clockwise CW direction forming outer windings (OW) of the card antenna CA (from an innermost turn to an outermost turn), then crosses over “x” (x1) itself and heads towards the interior of the card body (CB) whereat an inner portion IP of the coupler coil CC may be formed with turns of wire laid in the counter clockwise CCW direction (from an outermost turn to an innermost turn), then the wire crosses over “x” (x2) itself and heads towards the periphery of the card body (CB) for laying the extension antenna EA in a clockwise CW direction (from an outermost turn to an innermost turn), then the wire crosses over “x” (x3) itself for laying an outer portion OP of the coupler coil CC with turns of wire laid in the clockwise CW direction (from an outermost turn to an innermost turn), then the wire crosses over “x” (x4, x5) itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5I shows a configuration for the booster antenna BA wherein from the starting point “a”, the wire commences being laid in a clockwise CW direction forming outer windings (OW) of the card antenna CA (from an innermost turn to an outermost turn), then crosses over “x” itself and heads towards the interior of the card body (CB) whereat an inner portion IP of the coupler coil CC (compare “iw”, FIG. 1F) may be formed with turns of wire laid in the counter clockwise CCW direction (from an outermost turn to an innermost turn), then the wire crosses over “x” itself for laying the extension antenna EA in a counter clockwise CW direction (from an outermost turn to an innermost turn), then the wire crosses over “x” itself for laying an outer portion OP of the coupler coil CC (compare “ow”, FIG. 1F) with turns of wire laid in the counter clockwise CCW direction (from an outermost turn to an innermost turn), then the wire crosses over “x” itself and heads towards the periphery of the card body (CB) for laying the inner windings (IW, compare FIG. 1B) of the card antenna CA which may be laid in a clockwise CW direction (from an innermost turn to an outermost turn), until the finishing point “f”. the entire sequence may be performed in reverse, starting at the point “f” and finishing at the point “a”.

FIG. 5J is described hereinbelow.

The following table presents possible “laying” senses of the various components CA (OW, IW), CC, EA of the booster antenna BA, typically starting at “a” and finishing at “f”.

| | OW of CA | CC | EA | IW of CA |
|---|---|---|---|---|
| FIG. 5D | CW | CCW | CW | CW |
| FIG. 5E | CW | CCW | CCW | CW |
| FIG. 5F | CW | CCW | CW | CW |
| FIG. 5G | CW | CCW | CCW | CW |
| FIG. 5H | CW | (IP) CCW | CW | CW |
| | | (OP) CW | | |
| FIG. 5I | CW | (IP) CCW | CCW | CW |
| | | (OP) CCW | | |
| FIG. 5J | CW | (iw) CCW | CCW | CW |
| | | (ow) CCS | | |

Although not specifically directed to the antenna module AM, the configurations of and improvements to booster antennas disclosed herein may provide for improved coupling of the booster antenna BA with the antenna module AM, and consequent improvements in “read distance” and “activation distance”.

According to some embodiments (examples) of the invention, a booster antenna (BA) may comprise a card antenna (CA) component disposed around a periphery of a card body (CB) and comprising an inner winding (IW) and an outer winding (OW); a coupler coil (CC) component disposed at a location for an antenna module (AM) on the card body (CB); and an extension antenna (EA) component; and may be characterized in that: at least one of the components is laid having a sense which is opposite one or more of the other components. At least some of the components may have innermost and outermost turns; at least one of the components is laid from an innermost turn to an outermost turn; and at least another of the components is laid from an outermost turn to an innermost turn.

### Some Additional Embodiments

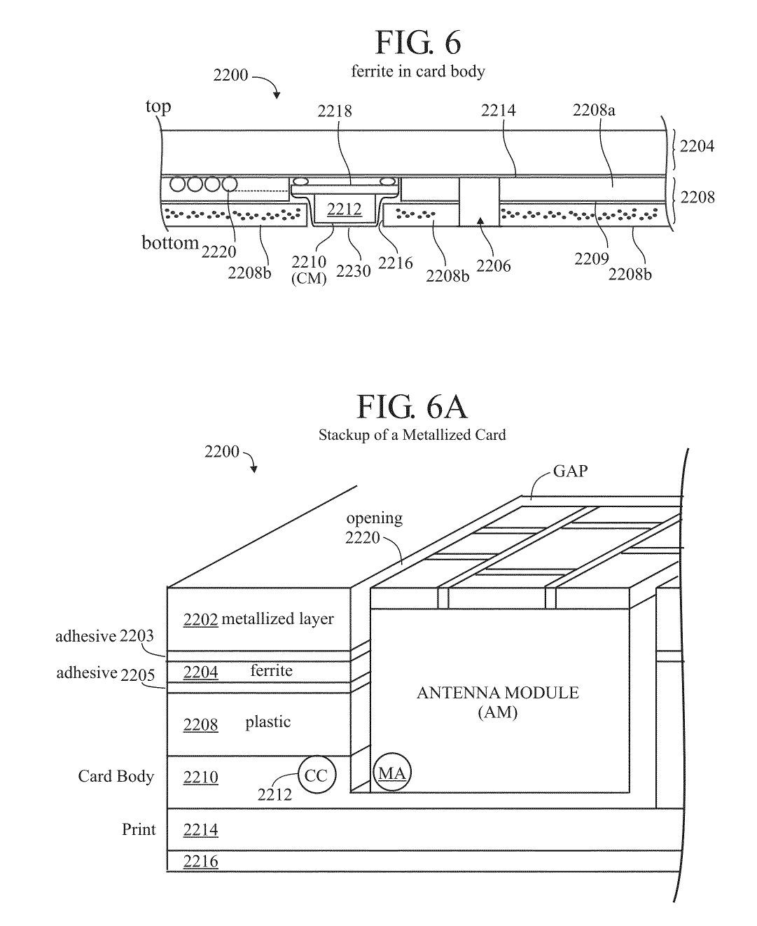

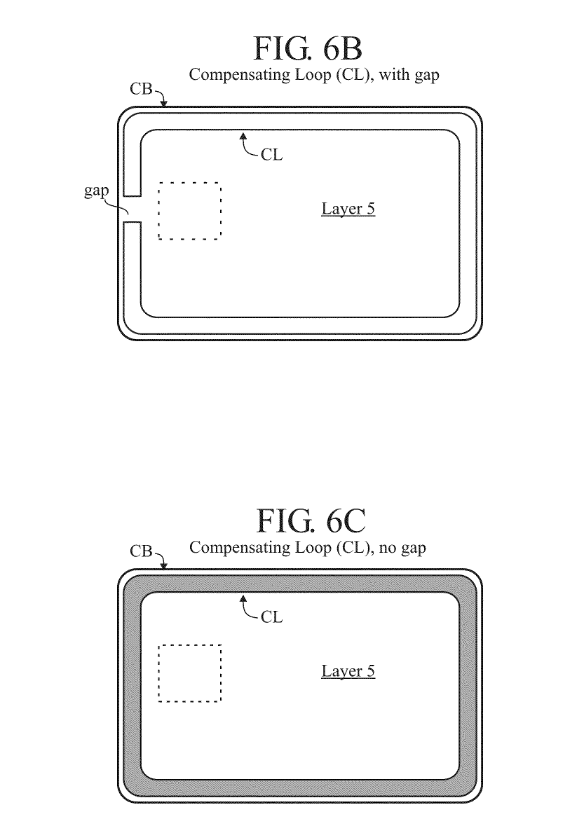

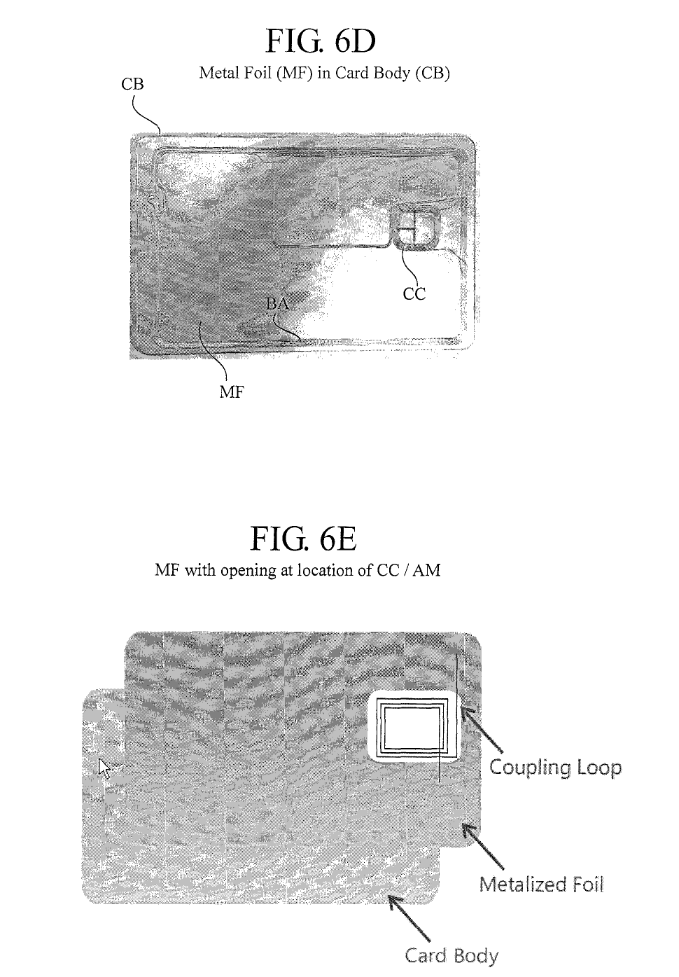

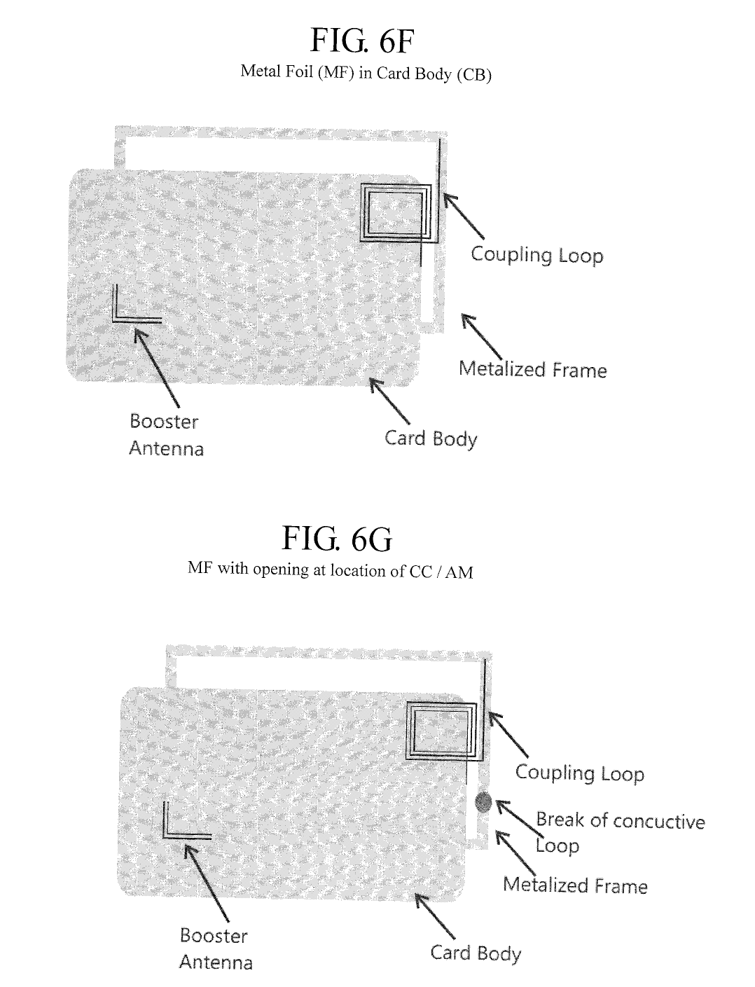

FIG. 6 (FIG. 22 of S59) is a cross-sectional view, illustrating a secure document (such as a passport cover) having ferrite in the inlay substrate (or card body).

FIG. 6A (FIG. 22A of S59) is a partial diagrammatic perspective view of a smartcard with metallization.

FIG. 6B (FIG. 22B of S59) shows a compensating loop (CL) with a gap.

FIG. 6C (FIG. 22C of S59) shows a compensating loop (CL) without a gap.

FIG. 6D, E, F, G (FIGS. 22D, E, F, G of S59) are illustrations of including a metal foil (MF) in the card body (CB).

### Ferrite and Metal Layers in the Card Body (CB)

U.S. Ser. No. 12/545,825 filed Aug. 22, 2009 (US 20090315320, Dec. 24, 2009) discloses secure inlays for secure documents such as a passport comprising an inlay substrate may have laser ablated recesses within which a chip module is installed. Channels for an antenna wire may be formed in a surface of the substrate. Instead of using wire, the channels may be filled with a flowable, conductive material. Patches homogenous with the substrate layer may be used to protect and seal the chip and interconnection area. The inlay substrate may include two layers, and the antenna wire may be between the two layers. A moisture-curing polyurethane hot melt adhesive may be used to laminate a cover layer and the additional inlay substrate layers. The adhesive layer may include metal nanoscale powder and ink for electro-magnetic shielding. Additional security elements may include material that is optically changeable by an electro-magnetic field. Ferrite-containing layers may be incorporated in the inlay substrate.

FIG. 6 illustrates a secure document which may be an inlay 2200 suitable for use as a passport cover. The inlay 2200 comprises a multiple-layer inlay substrate 2208 and a cover layer 2204 cold laminated (adhesively attached, joined) to the inlay substrate 2208 with a layer 2214 of adhesive such as 50 μm, which may be applied by roller coater. It should be understood that at least some of the techniques disclosed herein may also be applicable to smart cards having a card body rather than an inlay substrate. Both smart cards and passport covers may have multiple layers, laminated together, recesses, and the like, as described herein.

The cover layer 2204 is generally a planar sheet or layer of flexible, durable, often “textile-type” material, such as PVC, coated offset board, with or without optical bleacher or acrylic coated cotton. The inlay substrate 2208 (both layers 2208a and 2208b) is generally a planar layer or sheet of flexible, durable, typically “plastic-type” material, such as Teslin™, PVC, Polycarbonate (PC), polyethylene (PE) PET (doped PE), PETE (derivative of PE), and the like. The material of the inlay substrate may be referred to as “synthetic paper”. The inlay substrate, or a bottom layer thereof (particularly when the antenna is embedded on a top surface of the top layer), can also be conductive, such as a ferrite-coated or ferrite-containing substrate to reflect or absorb electromagnetic energy. This is indicated by the particles (dots) in the bottom inlay substrate layer 2208b.

A hinge gap 2206 is shown, and may simply be a gap, approximately 1 mm wide, between a left (as viewed) portion of the inlay substrate 2208 and a right (as viewed) portion of the inlay substrate 2208. The left portion of the inlay 2200 corresponds to the front of the passport cover, and the right portion of the inlay 2200 corresponds to the back portion of the passport cover. The hinge gap 2206 may not completely separate the back portion of the inlay substrate from the front portion, they may still be joined by a “web”. Typically, the gap is punched or cut after adhesive coating and pre-press lamination (to smooth the surface)

The cover layer 2204 is generally a planar sheet or layer of flexible, durable, often “textile-type” material, such as PVC, coated offset board, with or without optical bleacher or acrylic coated cotton.

The inlay substrate 2208 (both layers 2208a and 2208b) is generally a planar layer or sheet of flexible, durable, typically “plastic-type” material, such as Teslin™, PVC, Polycarbonate (PC), polyethylene (PE) PET (doped PE), PETE (derivative of PE), and the like. The material of the inlay substrate may be referred to as “synthetic paper”.

The inlay substrate 2208, or a bottom layer thereof (particularly when the antenna is embedded on a top surface of the top layer), can also be conductive, such as a ferrite-coated or ferrite-containing substrate to reflect or absorb electromagnetic energy. This is indicated by the particles (dots) in the bottom inlay substrate layer 2208b.

An antenna wire 2220 may be mounted to a top surface of the inlay substrate 2208, and an RFID chip (CM) 2210 may be disposed in a recess 2216 extending into the inlay substrate 2208 from a top surface thereof. The antenna wire 2220 may comprise 4 or 5 turns of wire, such as approximately 80 μm diameter (thick) wire. Ends of the antenna wire 2220 are connected to terminals of the chip (CM) 2210.

The recess 2216 may be a window-type recess extending completely through the inlay substrate 2208 to the bottom surface thereof. of the inlay substrate.

The chip (CM) 2210 may be a leadframe-type chip module comprising a chip mounted on a leadframe 2218 and encapsulated by a mold mass (MM) 2212. The leadframe 2218 may be approximately 80 μm thick and 8 mm wide. The mold mass 2212 may be approximately 240 μm thick and 5 mm wide. The chip (CM) 2210 may have an overall size (width dimensions) of 5.1×8.1 mm and an overall thickness of 320 μm. The width of the recess 2216 should be sufficient to accommodate the chip module (including leadframe 2218), with some clearance.

The inlay substrate 2208 may comprise two or more layers 2208a and 2208b which are laminated (adhesively attached, joined) one another with a layer (or layers) 2209 of adhesive such as 50-80 μm, which may be applied by a roller coater. In the main hereinafter, a two-layer example of an inlay substrate 2208 will be described, comprising an upper (topmost) layer 2208a and a lower (bottommost) layer 2208b.

The recess 2216 for the chip module 2210 extends into the inlay substrate 2208 from the top surface of the topmost layer 2208a, through the topmost layer 2208a, and at least partially into the bottommost layer 2208b. The recess 2216 extends fully through the entire inlay substrate 208, including fully through the bottommost layer 2208a, exiting the inlay substrate 2208 at the bottom of the bottommost layer 2208b.

The recess 2216 may be “stepped” so that it has a larger width dimension opening at the top surface of the inlay substrate 2208 than at the bottom surface of the inlay substrate 2208. For example, a top portion of the recess 2216, for accommodating the leadframe 2218 may measure 5.3 mm×8.1 mm, and a bottom portion of the recess 2216 for accommodating the mold mass 2212 may measure 5.1 mm×5.1 mm. The stepped recess 2216 may be formed by a first opening having a first width dimension in the topmost layer 2208a, second opening having a second width dimension in the next adjacent (which is the bottommost) layer 2208b. When the layers 2208a and 2208b are assembled with one another, the openings in the layers 2208a and 2208b are aligned (such as concentric) with one another. The first width dimension is different than the second width dimension. The first width dimension, for accommodating the leadframe, is shown greater than the second width dimension, for accommodating the mold mass (MM) 2212.

The openings of the recess 2216 in the layers 2208a and 2208b may be any appropriate shape, such as rectangular for a rectangular chip module or circular for a circular (round) chip module (CM). The openings may be formed by a mechanical punch operation. The chip module 2210 may be disposed in the recess 2216 in such a way that the leadframe 2218 is nearly flush with the upper surface of the top substrate layer 2208a and the mold mass of the chip module is nearly flush with a bottom side of the bottom substrate layer 2208b. However, note that the end portions of the antenna wire 2220 are connected (bonded) to the top surface of the leadframe 2218 (opposite the chip and mold mass which are on the bottom surface of the leadframe 2218. Also note that the diameter of the antenna wire 2220 is decreased where it is bonded to the leadframe 2218. For example, the 80 μm wire may be compressed to approximately 40 μm during thermo-compression bonding. The antenna wire 2220 may be embedded (disposed) in a top surface of the topmost substrate layer 2208a, and is connected with a top surface of the leadframe 2218.

In the finished inlay substrate 2208, which may be considered an “interim product”, all of the components (chip CM 2210 and antenna 2220) mounted in or to the inlay substrate 2208 should not project beyond the surface of the inlay substrate 2208.

According to some embodiments (examples) of the invention, a card body (CB) for a smart card (SC, 2200) may comprise at least two layers of a synthetic material and a recess extending through a top of the two layers and at least into a bottom of the two layers; and may be characterized by at least one of: a metallized layer (2202); a compensating loop (CL) having a gap; a compensating loop (CL) without a gap; metal foil (MF); metal foil (MF) having an opening at a location of an antenna module (AM); and ferrite (FE) in the card body. The recess may extend through the bottom layer. An antenna module (AM) may be disposed in the recess. An antenna wire may be disposed between the at least two layers, or on a top surface of the top layer. Ferrite particles may be disposed in the bottom layer.

According to some embodiments (examples) of the invention, a method of making a secure document comprising an inlay substrate may comprise: providing the inlay substrate as at least two layers of a synthetic material, such as Teslin™, laminated to one another with a layer of adhesive; and providing a recess for a chip module in the substrate; and may be characterized by at least one of: providing a metallized layer (2202); providing a compensating loop (CL) having a gap; providing a compensating loop (CL) without a gap; providing a metal foil (MF); providing a metal foil (MF) having an opening at a location of an antenna module (AM); and providing a ferrite element (FE) in the card body. The recess may extend through a top of the two layers and at least into a bottom of the two layers. Ferrite particles may be disposed in at least one of the layers. An antenna wire may be disposed on one of the layers or between the at least two layers.

### Metallized Surfaces

Some smartcards, including dual interface (DI) smartcards, have a metal (or metallized) top layer, or “face plate”, substantially the size of the card body. Having a metal layer is technically disingenuous in that a it may significantly reduce coupling between the card and an external contactless reader. Nevertheless, the feature may be important for vanity purposes.

An exemplary stackup of layers for a metallized card may comprise the following layers. The layers are numbered for reference purposes only, not to indicate a particular sequence. The sequence may be as indicated, or the layers may be rearranged. Some layers may be omitted. Some layers may be applicable to either non-metallized smartcards or metallized smartcards. Some of the layers may comprise more than one layer. Some layers may be combined with other layers.

Layer 1 printed sheet, overlay anti-scratch, etc

Layer 2 separate metal layer or metallized foil

Layer 3 booster antenna BA with coupler coil CC

Layer 4 card body CB

Layer 5 compensation frame (back side of card body) on metallized or non-metallized

Layer 6 printed sheet, underlay anti-scratch, magnetic stripe, etc

An RFID chip (CM) may be disposed in a window “W” (opening) extending into the smartcard, from the front (Layer 1), through the metallized foil (Layer 2) and into the card body (Layer 4). The chip (CM) may have contact pads (CP) on its front surface for interfacing with an external contact reader. The chip (CM) may be a dual interface (DI) antenna module (AM) having a module antenna (MA) for interfacing, via the booster antenna (BA) with coupler coil (CC), with an external contactless reader. The antenna module (AM) may fit within the inner area of the coupler coil (CC).

FIG. 6A is a partial diagrammatic perspective view of a smart card with metallization showing an exemplary stackup (sequence of layers) for a metallized smart card 200, having the following layers, structures and components. Exemplary dimensions may be presented. All dimensions are approximate. Thickness refers to vertical dimension in the figure.
A top layer 2202 may be a metal (or metallized) layer 2202, such as 250 μm thick stainless steel, and may be referred to as a “face plate”. Compare “Layer 1”. This top layer 202 may be as large as the overall smart card, such as approximately 50 mm×80 mm.
A layer 2203 of adhesive, such as 40 μm thick of polyurethane
A layer 2204 of ferrite material, such as 60 μm thick sheet of soft (flexible) ferrite
A layer 2205 of adhesive, such as 40 μm thick of polyurethane
A layer 2208 of plastic material, such as 50-100 μm thick PVC, which may function as a spacer (separating layers and components below from those above)
A layer 2210 of plastic material, such as 150-200 μm thick PVC, which may function as the card body (CB). Compare “Layer 4”.
Wire 2212, such as 112 μm diameter wire, forming the booster antenna (BA) with coupler coil (CC). Only one wire cross-section is shown, for illustrative clarity.
A layer 2214 of plastic material, such as 150 μm thick PVC, which may include printing, magnetic stripe, etc.
A layer 2216 of plastic material, such as 50 μm thick PVC, which may serve as an overlay
The overall thickness of the smart card 200 (layers 2202, 2203, 2204, 2208, 2210, 2214, 2216) may be approximately 810 μm (0.81 mm).

A window opening 2220 (“W”) may extend into the smart card from the face plate 202, through intervening layers, into the card body layer 2210. A dual interface (DI) antenna module (AM), with module antenna (MA) may be disposed in the window opening 2220. The window opening may extend completely through the layer, in which case the antenna module (AM) would be supported by the underlying layer.

The coupler coil (CC) of the booster antenna (BA) may surround the window opening 2220 so as to be closely coupled with the module antenna (MA) of the antenna module (AM). Alternatively, the coupler coil (CC) may be disposed in the card body (CB) so as to be underneath the module antenna (MA) of the antenna module (AM).

The antenna module (AM) may measure approximately 12×13 mm (and approximately 0.6 mm thick). The window opening 2220 (“W”) in the face plate 2202 may be approximately the same size as the antenna module (AM)—i.e., approximately 12×13 mm. In this “baseline” configuration, the chip activation distance may be approximately 15 mm. (Chip activation distance is similar to read distance, and represents the maximum distance at which the chip module may be activated (for reading) by an external reader. As a general proposition, more is better, 15 mm is not very good, 20 mm or 25 mm would be better. The chip activation distance in a metallized smart card is handicapped by attenuation of the electromagnetic field associated with the booster antenna attributable to the metallic face plate 202 (Layer 1).

The window opening 2220 in the face plate 2202 may be made to be significantly larger than the antenna module (AM) so as to offset shielding and enhance coupling, thereby increasing the activation distance.

The ferrite layer 2204 may also improve coupling by reducing attenuation of coupling by the face plate 2202, helping to concentrate the electromagnetic field between the booster antenna BA and the module antenna MA of the antenna module AM. It may be desirable that the ferrite layer 2204 be as close as possible to the underside of the face plate 2202. Rather than having a separate ferrite layer 2204 (and adhesive layer 2203), ferrite particles or powder may be mixed with an adhesive and sprayed or coated onto the underside of the face plate 202, thereby eliminating the intervening adhesive layer 203. Alternatively, rather than being in the form of a separate layer 2204, the ferrite material may be particles (including nanoparticles) of ferrite embedded in an underlying layer, such as the spacer layer 2208 or the card body layer 2210 (in some configurations, the spacer layer 2208 may be omitted).

The spacer layer 2208 may also improve coupling by reducing attenuation of coupling by the face plate 2202, simply by keeping the face plate 2202 as far away as practical (within the confines of the form factor for smart cards) from the booster antenna 2212.

Note in FIG. 6A that the antenna module AM goes through an opening in one layer 2208 and thereafter at least partially into an underlying layer 2210, such as in the manner described with respect to FIG. 6.

A coupling loop (CL) (or “compensating loop”, or “compensation frame”, or variants thereof) may be disposed between some of the layers, for example between the card body layer 2210 and the underlying print layer 2214.

### Compensating Loops in the Card Body (CB)

FIG. 6B shows that a conductive “compensating loop” CL may be disposed in a layer, such as behind the booster antenna BA (Layer 3), extending around the periphery of the card body CB. The compensating loop CL may be an open loop having two free ends, and a gap (“gap”) therebetween, and is discontinuous. The compensation loop CL may be made of copper cladding, can be printed on a support layer, etc. FIG. 6C shows that the compensating loop CL may be “closed”, having no gap and no free ends, or a continuous ring of material.

The compensating loop CL may comprise ferrite material, and may be referred to as a “frame”. The compensating loop CL on the reverse side of the booster antenna BA (away from the antenna module AM) may help with the stabilization of the resonance frequency. The compensating loop CL may be used in addition to the booster antenna BA. The booster antenna BA may be embedded into one side of an inlay substrate while the compensation frame may be inkjet printed or adhesively attached to the opposite side of the inlay substrate. The compensation loop CL can be mounted using a subtractive (etching away of material) or additive (depositing material) process.

### Metal Foil Layer(s)

Metal foils, metallic coatings, segments of metal foil or metal particles may be deposited on or embedded in the inlay (or card body CB) to alter the electrical characteristics of the RFID device or smartcard. A metal foil layer in the card body construction may helps to meet the ISO and EMV communication standards for RFID devices or smart cards in terms of read write distance, baud rate, Q-factor bandwidth, etc. The metal foil can be any pure metal such as aluminum or copper or an alloy. The metal foils, metallic coatings, segments of metal foil or metal particles should have a thickness less than the skin depth of the metal or material being used in order to prevent the formation of eddy currents in the metal or metallic structure that will attenuate the RF electromagnetic field. The use of thicknesses substantially less than the skin depth of the metal or material being used will increase the electrical resistance of the structure to alternating current flows (impedance) thereby preventing unwanted or excessive attenuation of the RF electromagnetic field. Other electrical conductors such as metal nanoparticles, metal nanowires or carbon-based conductors like graphite or exfoliated graphite can be used to construct electrically conductive networks that are hereby included under the definition of a metal foil or metallic structure.

The booster antenna (BA) is normally constructed from a track of wire embedded in an inlay substrate (or card body CB) comprising one or more layers of a material such as Polyvinyl Chloride (PVC), Polycarbonate (PC), Polyethylene (PE), Poly(ethylene terephthalate) (PET), Polyetherurethane, PET-G (Polyethylene Terephtalate Glycol-modified), Polyester Copolymer film, Teslin™, paper, synthetic paper and the like. Alternatively, the booster antenna (BA) can be formed on the inlay substrate by chemically or laser etching a metal coating previously deposited on the substrate. A particular design of booster antenna (BA) with coupler coil (CC), having a certain geometry and number of coil windings, will exhibit specific electrical characteristics in terms of resonance frequency and impedance.

The metallic/metallized foil in the card stackup may exhibit “capacitive coupling” with the booster antenna (BA) to broaden the bandwidth of the Gaussian curve to include the side bands and to reduce the concentration of the electromagnetic flux at the position of the coupler coil CC (i.e. to avoid overpowering the RFID chip). This may improve the communication of signals carried between the RFID device (secure document or smartcard) and the reader on the sub-carrier frequencies (the sub-carrier frequencies is typically +/−848 kHz at 12.712 MHz and 14.408 MHz for a device operating at 13.56 MHz, as per ISO/IES 14443-2).

The metal foil or metallic structure can advantageously alter (such as lower) the quality factor (Q) of the booster antenna (BA). The metal foil or metallic structure can also have a capacitive effect in the circuit. The presence of the metal foil or metallic structure in the card design can alter the electrical power delivered to the IC chip (CM). Some or all of these effects may enhance the performance of the RFID device or smartcard, improving the coupling between the antenna module AM and the coupler coil CC of the booster antenna BA. The communication between the RFID device or smartcard and the reader can thus be improved.

The metal foil MF together with the booster antenna BA generates capacitance in the resonant circuit which may result in a broadening of the resonance curve and which may improve signal communication on the sub-carrier frequencies, typically at 12.712 MHz and 14.408 MHz (i.e. +/−848 kHz for a device operating at 13.56 MHz).

A metal foil, metal coating or metal particles can be implemented in the RFID device or smartcard in a number of ways as described hereunder. A very thin continuous metal foil can be deposited directly on top of the booster inlay (card body CB), behind the booster inlay or within the booster inlay structure. The metal foil can be supported on a plastic substrate, such as Poly(ethylene terephthalate) (PET), before being incorporated into the booster antenna structure.

FIGS. 6D-G shows methods of applying conductive material in the card body CB, which may reduce the Quality factor (Q) of the coupler coil CC to include sidebands and improve coupling between the coupler coil CC and the module antenna MA.

FIG. 6D illustrates a booster antenna (BA) placed on a transparent PVC substrate that has been laminated to a second PVC layer bearing a metal foil coating. The metal foil may have a thickness typically of the order of tens of nanometers (for example 15 nm). The thickness of the metal foil dictates the effect on the electrical properties of the RFID device or smartcard. The metal foil can deposited anywhere within the body of the card and may have a size matching the full area of the card body CB, or only a portion thereof. The foil can also be used to overlap only the booster antenna or parts of the booster antenna. Multiple areas of foils can be deposited within the card body to alter the performance effect. Additionally, multiple layers of foils can be deposited within a card body. The metal foil can be disposed on the PCV substrate without the intermediary of the second PVC layer.

As an alternative to a continuous metal foil, a perforated (or otherwise segmented or discontinuous) metal foil can be used. The perforations may allow the electromagnetic flux from the RFID reader to substantially penetrate the card body (CB). The perforated foil can be deposited anywhere within the card body, as described above. The thickness of a perforated foil may be greater than the thin continuous foils described above—for example, greater than 15 nm. (A continuous metal foil may have a thickness less than 15 nm.)

As an alternative to a continuous metal foil, a metal mesh can be used. The mesh can be deposited anywhere within the card body as described above. The metal mesh can also be constructed of a porous network

Metal particles of various sizes and shapes (including spheres and flakes) can be deposited on the surface of the booster antenna (BA) or an additional inlay layer within the card body. The metal particles can be formed a range of materials including metal alloys and can be deposited within the material used to form the inlay or other layers within the card body. The metal particles can also be derived from a conventional metallic finish on the surface of the card.

The metal foil MF or metallic structure can cover the full area of the RFID device or smartcard as illustrated in FIG. 6D or can partially cover the area leaving selectively exposed regions.

FIG. 6E illustrates an embodiment of the invention where the area of the coupling coil (or coupling loop) is left free of the metal foil. The metal foil MF or metallic structure partially covers the smartcard area, leaving exposed metal-free region at the coupling loop of the booster antenna (BA). This may substantially reduce (or prevent) attenuation of the inductive coupling between the coupler coil CC and the module antenna MA (not shown). This is illustrative of a metal foil or metallic structure partially covering the smartcard area, leaving an exposed metal-free region at the location of the coupling coil CC of the booster antenna (BA). The recess of (opening in) the metallized foil MF at the location of the chip module (underneath the coupling loop) may help to reduce the quality (Q) of the booster antenna without having destructive effects on the coupling between the booster antenna BA and the antenna module AM.

FIG. 6F illustrates a continuous metal loop or loop of a metallic structure is disposed on top of or below the booster antenna BA, and may cover part of the booster antenna BA. Compare FIG. 6C.

FIG. 6G illustrates a discontinuous (broken) metal loop or loop of a metallic structure is placed on top of or below the booster antenna, and may cover part of the booster antenna BA. In this case, the ends of the open loop may be left open or connected to a resistive load. Alternatively, a resistor can be formed by narrowing a section of the metal loop or metallic structure in order to locally reduce the cross sectional area of the loop.

The metal foils may comprise a conductive material (such as aluminum on PVC), having a sheet resistance which is very low, on the order of only a few Ohms, which normally should block the electromagnetic field (such as between the booster antenna BA and an external reader, or between the booster antenna BA and the antenna module AM), but a mitigating factor may be the thickness of the aluminum (or other material), being thin enough to allow the electromagnetic field to pass through.

Metal foils or substrate materials having metallized coatings may be used in the production of the booster antenna (BA) for RFID devices or smartcards. The metal can be any pure metal such as aluminum or copper or an alloy. Other electrical conductors such as metal nanoparticles, metal nanowires or carbon-based conductors like graphite or exfoliated graphite may also be used.

The booster antenna (BA) is normally constructed from a track of wire embedded in an inlay substrate comprising one or more layers of a material such as Polyvinyl Chloride (PVC), Polycarbonate (PC), Polyethylene (PE), Poly(ethylene terephthalate) (PET), Polyetherurethane, PET-G (Polyethylene Terephtalate Glycol-modified), Polyester Copolymer film, Teslin™, paper, synthetic paper and the like. Alternatively the booster antenna (BA) can be formed on the inlay substrate by chemically or laser etching a metal coating previously deposited on the substrate. A particular design of booster antenna (BA) with coupler coil (CC), having a certain geometry and number of coil windings, will exhibit specific electrical characteristics in terms of say resonance frequency and impedance. Metal foils, metallic coatings, segments of metal foil or metal particles may be deposited on or embedded in the inlay substrate or card body to alter the electrical characteristics of the RFID device or smartcard.

The effect of the metal or metallic structures can be to dampen the booster antenna (BA) resulting in a widening of the resonance curve of the booster antenna (BA) and lowering the quality factor (Q). The metal or metallic structure can also have a capacitive effect in the circuit.

These effects can enhance the performance of the RFID device or smartcard. The communication between the RFID device or smartcard and the reader can thus be improved.

The metal foil, metal coating or metal particles can be implemented in the device in a number of ways, for example, but not limited to:
(a) A very thin metal continuous metal foil can be deposited on the booster inlay or within the booster inlay. The metal can thin (less than 10 micron in thickness for example) or extremely thin (or the order of nanometers). The metal foil can deposited anywhere within the body of the card and may have size matching the full area of the card of part of the card. The foil can also be used to overlap only the booster antenna or parts of the booster antenna.
(b) A perforated metal foil can be used. The perforations allow the electromagnetic flux from the RFID reader to largely penetrate the card. The perforated foil can be deposited anywhere within the card as described in 1 above.
(c) A metal mesh can be used. The mesh can be deposited anywhere within the card as described in (a).

Metal particles of various sizes and shapes (including spheres and flakes) can be deposited on the surface of the booster antenna (BA) or an additional inlay within the card body. The metal particles can be formed a range of materials including metal alloys and can be deposited within the material used to form the inlay or other layers within the card body. The metal particles can also be derived from a conventional metallic finish on the surface of the card.

According to some embodiments (examples) of the invention, a card body (CB) for a smart card (SC) may comprise: a metal foil (MF) layer incorporated into the card body (CB); and may be characterized in that: the metal foil (MF) comprises a material selected from the group consisting of pure metals, alloys, aluminum, copper, metal nanoparticles, metal nanowires, carbon-based conductors, graphite, and exfoliated graphite; and the metal foil may be characterized by one or more of: the metal foil comprises a very thin continuous layer deposited on the card body (CB); the metal foil has a size matching an area of the card body (CB), or only a portion thereof; the metal foil overlaps only the booster antenna (BA) or portions or components of the booster antenna; the metal foil comprises multiple areas of foils which are deposited on or in the card body (CB); the metal foil is perforated, segmented or discontinuous; the metal foil is continuous, and has a thickness less than 15 nm; the metal foil is discontinuous, and has a thickness greater than 15 nm; the metal foil comprises a mesh; the metal foil comprises metal particles of various sizes and shapes; the metal foil partially covers the smartcard area, leaving exposed metal-free region at a coupling coil (CC) of the booster antenna (BA); the metal foil reduces the quality (Q) of the booster antenna without having destructive effects on the coupling between the booster antenna (BA) and the antenna module (AM); the metal foil comprises (FIG. 22F) a continuous loop; the metal foil comprises (FIG. 22G) a discontinuous loop; the metal foil comprises a resistor formed by narrowing a section of a metal loop; and the metal foil comprises a conductive material having a sheet resistance on the order of only a few Ohms. The metal foil may be characterized by at least one of: the metal foil is continuous, and has a thickness of less than 10 μm; the metal foil is perforated; the metal foil comprises a mesh; and the metal foil comprises metal particles.

### on the Use of Ferrite, Generally

Ferrite layers may be laminated together, and in combination with a copper compensating loop CL on the reverse side of a booster antenna BA may stabilize the resonance frequency of the booster antenna BA. The track may be broken (have a gap) at some position.

Lamination and temperature may be used to sinter ferrite particles together to be a continuous path. Laminating ferrite particles under temperature and very high pressure to produce a thin card material film such as PC PVC PETG to produce a ferrite inlay with antenna. The inlay may consist of several layers of ferrite. The applied temperature and pressure may cause the particles to sinter and form an insulating layer of ferrite.

Depositing ferrite nanoparticles or powder onto an inlay substrate to bend the magnetic flux lines and to compensate for the effect of shielding caused by metallization of the printed layer(s) in a smart card body or any metal layer in close proximity to an RFID antenna in card body; and forming a pre-laminated inlay with a booster antenna or transponder with one or several underlying layers of ferrite which have been laminated together with the RFID components to form a composite inlay layer

Ferrite nanoparticles or powder can be applied to a substrate layer by means of wet or dry spraying. In the case of wet spraying the ferrite is suspended in a liquid phase dispersion which is prepared through sonication of the particles in a solvent or aqueous/surfactant liquid. The particles may also have a steric wrap to support the suspension of the particles in the liquid. The mean crystal particle size of the ferrite spheres can be determined by filtering and by the degree of sonication over time. (Sonication is the act of applying sound, usually ultrasound energy to agitate particles in a sample.)

The sintering of the nano-sized ferrite particles occurs during hot lamination of the synthetic layers which make up the inlay. The lamination process includes heating and cooling under high pressure. Several layers of ferrite coated substrates or foils can be used to enhance the ferromagnetic properties. Unlike bulk ferrite granules, nanoparticles have a much lower sintering temperature, matching the glass transition temperature of the synthetic substrate. Additional heat treatment after lamination may be required.

### Some Additional Features

Iron or ferromagnetic particles or flakes could be selectively deposited in the areas between the antenna.

The booster antenna BA may be tuned, after lamination, to be below the resonance frequency of 13.56 MHz, rather than above.

Holographic metal foils may be glued or laminated to both sides of the booster antenna BA inlay (card body DB). The holographic metal foils may not significantly attenuate the electromagnetic field, in other words the holographic metal foils may be largely transparent to the RF field. The holographic metal foils can be used to mask (visually hide) the presence of the booster antenna BA. In addition, the holographic metal foils when placed either side (above, below) of the booster antenna BA can generate capacitance which may help improve the communication performance of the smart card with the reader (FIG. 1).

One or more turns on the coupler coil CC can be routed in the area directly beneath the antenna module AM. Placing some turns of the coupler coil CC directly under the antenna module AM, and consequently close to the module antenna MA, may increase the coupling between the booster antenna BA and the antenna module AM, resulting in improved power delivery to the chip IC (CM), thereby improving smart card performance.

Some Contrasts with U.S. Pat. No. 8,393,547

The dual interface card may be contrasted with the RF proximity financial transaction card of Kiekhaefer (U.S. Pat. No. 8,393,547) in various ways, including but not limited to:

The dual interface card of the present invention has a booster antenna BA with a coupler coil CC. The booster antenna BA is inductively coupled, rather than “operatively connected” with the chip module CM. In Kiekhaefer, the “antenna carried by said inlay . . . is operatively connected to said integrated circuit”.
“The connections between the antenna and the chip can be made by direct contacts, each end of the antenna then being physically connected according to known techniques to a respective connector on the chip. The connections can also be made without contact, in this case the chip includes an inductor and the antenna includes an induction coil which interacts with the chip inductor.” (column 2, lines 56-62)

The module antenna MA of the antenna module AM and the coupler coil CC of the booster antenna are inductively coupled with one another, they are not electrically connected with one another. As is well known, in electrical engineering, two conductors are referred to as mutually-inductively coupled or magnetically coupled when they are configured such that change in current flow through one wire induces a voltage across the ends of the other wire through electromagnetic induction. The amount of inductive coupling between two conductors is measured by their mutual inductance. The coupling between two wires can be increased by winding them into coils and placing them close together on a common axis, so the magnetic field of one coil passes through the other coil. The two coils may be physically contained in a single unit, as in the primary and secondary sides of a transformer, or may be separated. Coupling may be intentional or unintentional.

A transformer is a static device that transfers electrical energy from one circuit to another through inductively coupled conductors—the transformer's coils (windings). A varying current in the first or primary winding creates a varying magnetic flux in the transformer's core and thus a varying magnetic field through the secondary winding. This varying magnetic field induces a varying electromotive force (EMF) or “voltage” in the secondary winding. This effect is called mutual induction.

In Kiekhaefer, “the substrate 4a carries an integrated circuit 4e for storing card-specific data and an antenna 4f operatively connected to the integrated circuit.”

In Kiekhaefer, the metallic foil layer has a peripheral edge that is substantially coextensive with said continuous peripheral edge of said plastic inlay. (see claim 1)

Kiekhaefer financial transaction card is not a dual interface card. Nor is it a national identity card. Kiekhaefer is not a dual interface card.

As is clearly shown in FIG. 6A herein, there is an opening 2200 in the metallized layer 2202 to accept the antenna module AM. This opening must be at least as large as the antenna module AM, and may be made larger than shown so that the coupler coil CC 2212 is also exposed through the opening. The layers shown in FIG. 6A may be rearranged in any suitable manner, for example so that the metallized layer is below, rather than above the card body 2210.

Additionally, the metallized layer 2210 may be sized so that it is entirely within the card antenna CA component (of the booster antenna BA) which extends around the periphery of the card body CB, and does not overlap it. Refer to FIG. 1 for the various components of the booster antenna.

With the booster antenna BA inductively coupled (via the coupler coil CC) to the antenna module AM (via the module antenna MA), effects of the metal layer ML 2202 may be compensated for, such as by performing one or more of the following techniques:
altering the number of turns in any of the booster antenna components,
altering the pitch between turns of any of the components of the booster antenna
selecting the gauge of wire used for the booster antenna,
choosing the material (composition) of the wire used for the booster antenna,
varying the resistance of the wire used for the booster antenna,

### A Booster Antenna Design

U.S. Ser. No. 14/225,570 filed 26 Mar. 2014 (20140209691 31 Jul. 2014), filed by Finn and Lotya discloses (at FIG. 1A) an exemplary design and layout (configuration) for a booster antenna (BA) of a smart card having a card antenna (CA) component, a coupler coil antenna (CC) component and an extension antenna (EA) component.

The card body CB—which may be referred to as a substrate, or an inlay substrate—may generally comprise one or more layers of material such as Polyvinyl Chloride (PVC), Polycarbonate (PC), PET-G (Polyethylene Terephtalate Glycol-modified), Copolyester (Tritan), Teslin™, synthetic paper, paper and the like. When “inlay substrate” is referred to herein, it should be taken to include “card body”, and vice versa, as well as any other substrate for a secure document, unless explicitly otherwise stated.

The card body CB may be generally rectangular, measuring approximately 54 mm×86 mm (refer to ISO/IEC 7810), having a thickness of approximately 300 μm thick. The card body CB is typically significantly (such as 20 times) larger than the antenna module AM.

The booster antenna BA may generally comprise a relatively large winding which may be referred to as a card antenna CA component (or portion) having a number of turns disposed in a peripheral area of the card body CB, and a relatively small coupler coil (or coupler antenna) CC component (or portion) having a number of turns disposed at a coupling area of the card body CB corresponding to a location of the antenna module AM, and an extension antenna EA component disposed in an upper portion of the card body CB (avoiding an embossing area in a lower portion of the card body CB). The booster antenna BA (and its various components) may comprise wire mounted to (embedded in) the card body CB using an ultrasonic tool comprising a sonotrode and a capillary. See, for example U.S. Pat. No. 6,698,089 and U.S. Pat. No. 6,233,818. The wire may be non-insulated, insulated, or self-bonding wire, having an exemplary diameter in the range of approximately 50-112 μm.

FIG. 5J is a diagram showing a configuration for a booster antenna (BA) of an smart card having a card antenna (CA) component, a coupler coil antenna (CC) component and an extension antenna (EA) component.

### Booster Antennas

Booster antennas (BA) in the card body (CB) of a smart card improve coupling between the antenna module (AM) with an external contactless reader, Several examples of booster antennas (BAs) are shown and described in the following applications or publications.
U.S. Ser. No. 13/600,140 filed 30 Aug. 2012 (US 20130075477 published 28 Mar. 2013)
U.S. Ser. No. 14/020,884 filed 8 Sep. 2013 (US 20140091149; 03 Apr. 2014)
U.S. 61/905,134 filed 15 Nov. 2013
U.S. 61/914,996 filed 12 Dec. 2013
U.S. Ser. No. 14/173,815 filed 6 Feb. 2014

Generally, a booster antenna BA may comprise a single length of wire, having two free ends “a” and “f”, mounted to (or embedded in) a surface of a synthetic substrate (or card body CB), and may comprise a card antenna CA component disposed around the periphery of the card body CB, a coupler coil CC component disposed at an interior area of the card body CB at a location corresponding to the location of an antenna module AM, and an extension antenna EA disposed at an upper portion of the card body CB.

Each of the booster antenna components (CA, CC, EA) may comprise several turns (or tracks) of wire which may be laid in a clockwise CW direction (with a first “sense”) or in a counter-clockwise CCW direction (with an opposite “sense”). The pitch of the turns may be different for each of the booster antenna components (CA, CC, EA). The turns of a given booster antenna component (CA, CC, EA) may be organized into a number of turns comprising an inner winding (IW, iw) and a number of turns comprising an outer winding (OW, ow) disposed around the inner windings of the component. The laying of the various booster antenna components (CA, CC, EA) may involve wire crossing over previously laid components, or portions thereof.

FIG. 5J shows an exemplary booster antenna BA comprising a card antenna CA component, a coupler coil CC component and an extension antenna EA component. The overall booster antenna BA may have two free ends “a” and “f”, and may be formed by embedding wire in an inlay substrate (or card body), such as in the following illustrative steps “1” to “5”:
1. starting at the free end “a” of the card antenna CA component, laying the wire for the outer winding OW, in a clockwise CW direction, from an innermost turn to an outermost turn thereof, around (just within) the periphery of the card body CB (not shown),
2. then, crossing over the already laid turns of the outer winding OW of the card antenna CA component, heading towards the interior of the card body CB and commencing laying the wire for the coupler coil CC component, in a counter-clockwise CCW direction, from an outermost turn to an innermost turn thereof,
3. then, crossing over the already laid turns of the coupler coil CC component, commencing laying the wire for the extension antenna EA component, in a counter-clockwise CCW direction, from an outermost turn to an innermost turn thereof,
4. then, crossing over the already-laid turns of the extension antenna EA component, heading back towards the periphery of the card body CB and commencing winding the inner winding IW of the card antenna CA component in a clockwise CW direction, from an innermost turn to an outermost turn thereof, within the already laid outer winding OW,
5. finishing laying of the wire for the booster antenna BA at the free end “f”, which may be (but need not be) close to the other free end “a”.

### Booster Antenna Patch for Contactless Reader

U.S. 62/006,085 filed 31 May 2014 by Finn and Ummenhofer discloses BOOSTER ANTENNA PATCH FOR CONTACTLESS READER. The disclosure relates to smartcards (or smart cards) and the like, operating at least in a contactless mode (ISO 14443). The smartcard (SC) may be a dual interface (DI) card which also has contact pads (CP) for interfacing with a contact reader. The smartcard (SC) may comprise an inlay substrate or card body (CB), an antenna module (AM), and a booster antenna (BA). The antenna module (AM) may comprise an RFID (radio frequency identification) chip or IC (integrated circuit) (CM) and a module antenna (MA). The disclosure may relate more particularly to improvements to contactless readers.

U.S. Ser. No. 14/281,876 filed 19 May 2014 (20140284386 25 Sep. 2014), entitled LASER ABLATING STRUCTURES FOR ANTENNA MODULES FOR DUAL INTERFACE SMARTCARDS, incorporated by reference herein, discloses laser etching antenna structures (AS) for RFID antenna modules (AM), including combining laser etching and chemical etching, limiting the thickness of the contact pads (CP) to less than the skin depth (18m) of the conductive material (copper) used for the contact pads (CP), multiple antenna structures (AS1, AS2) in an antenna module (AM), and incorporating LEDs into the antenna module (AM) or smartcard (SC).

Dual interface (DI or DIF) smartcards (more generally, secure documents) may comprise an antenna module (AM) with a number of (typically 6 or 8) contact pads (CP) connected with an RFID chip (CM) via wire bonds or flip chip assembly, and a booster antenna (BA) in the card body (CB) consisting of a card body antenna (CA), an extension antenna (EA) and coupling coil (CC) which inductively couples with the module antenna (MA) of the antenna module (AM). The RFID chip may be referred to as a “chip IC”.

The booster antenna (BA) may comprise various antenna components, such as a card body antenna (CA) for coupling with an external contactless reader, an extension antenna, and a coupling coil (CC) for coupling with the module antenna (MA) of the antenna module (AM).

The antenna module AM may generally comprise a “DI” RFID chip (bare, unpackaged silicon die) or chip module (a die with leadframe, carrier, redistribution substrate, interposer or the like)—either of which may be referred to as “CM”—mounted to a module tape “MT”. A module antenna “MA” may be disposed on the module tape MT for implementing a contactless interface. An array of contact pads “CP” may be disposed on the module tape MT for implementing the contact interface.

The overall dimensions of the antenna module (AM) may be approximately 11.8 mm×13 mm (8 contact pad) or 10.6 mm×8.0 mm (6 contact pad). The overall dimensions of the card body (CB) may be approximately 54 mm×86 mm. The overall dimensions and pattern of the contact pads (CP) may be specified by ISO 7816. The contact pads (CP) occupy a “contact pad area” on the face-up side of the antenna module (AM), and may have a thickness of approximately 30 μm (30 microns) as standard.

It is a general object of the invention to provide techniques for improving the operation of RFID devices (smartcards, tags and the like) having antenna modules AM and operating at least in a contactless mode (ISO 14443).

Some of the techniques disclosed herein may be applicable to dual interface (or dual-interface, contact and contactless interfaces) or single interface (contactless only) smartcards (or other RFID devices), including smartcards with metallization (“metal” smartcards). Some of the techniques disclosed herein may be applicable to small form factor transponder devices.

As disclosed in U.S. Ser. No. 14/281,876, a reader antenna may be modified to have antenna components similar to those of a booster antenna, namely a perimeter (card body) antenna (CA) component, an extension antenna (EA) component and a coupler coil component. The position of the antenna components may differ to that of a booster antenna; for example, the coupler coil (CC) could be in the center of the card antenna (CA). Alternatively, this antenna could be a separate antenna to that of the reader antenna. In this case the antenna on a suitable substrate may be attached or placed over the reader antenna in, for example, a payment terminal.

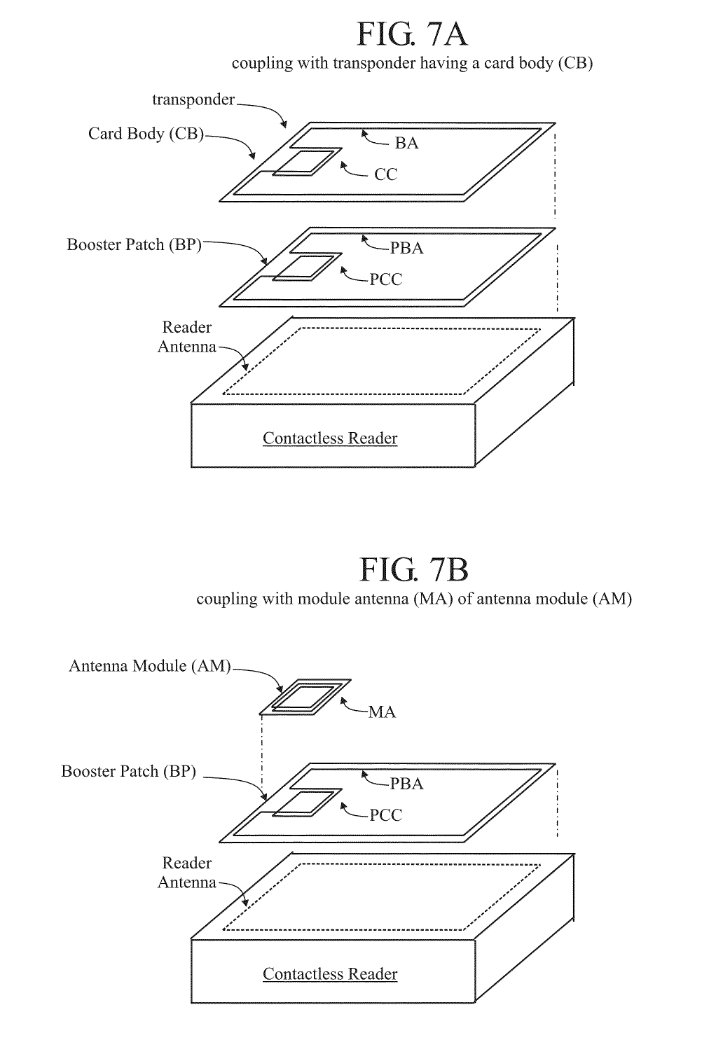

As disclosed in U.S. 62/006,085, generally, a substrate (or patch) having a patch booster antenna (PBA) with a patch coupler coil (PCC) component may be applied onto a contactless (ISO 14443) reader to enhance coupling with either of:
(FIG. 7A) a transponder having an antenna module (AM) with a module antenna (MA), and a card body (CB) with a booster antenna (BA) including a coupler coil (CC) component, or
(FIG. 7B) an antenna module (AM) with a module antenna (MA), without requiring a card body (CB) and booster antenna (BA).
FIG. 7A is a diagram, in perspective view, of a transponder having a card body (CB), a patch having a patch booster antenna (PBA), and a contactless reader.
FIG. 7B is a diagram, in perspective view, of a transponder without a card body (CB), a patch having a patch booster antenna (PBA), and a contactless reader.

The drawings are exemplary of the various embodiments of the invention. To avoid cluttering the drawings, some features such as plated through holes, conductive traces for interconnects, bond pads, and other features may be omitted from the drawings. Passivation metallization layers may also be omitted for clarity.

The booster antenna BA (and other features) disclosed herein may increase the effective operative (“reading”) distance between the antenna module AM and the external contactless reader with capacitive and inductive coupling. With reading distances typically on the order of only a few centimeters, an increase of 1 cm can represent a significant improvement.

A passive transponder device comprising an RFID chip or die connected to an antenna may be incorporated as a chip module or antenna module AM in RFID devices such as smartcards, tags and security documents. The antenna (or module antenna “MA”) can be wire wound, wire embedded, chemically etched (copper, silver, aluminum), sputtered and printed (conductive inks) on a variety of substrates. Such cards, tags and documents may comprise several substrate layers protecting the transponder device, and the layers may be laminated to form a composite product.

The descriptions that follow may be mostly in the context of dual interface (DI, DIF) smartcards, and may relate mostly to the contactless operation thereof. Many of the teachings set forth herein may be applicable to electronic passports, keyless (contactless) entry systems and the like having only a contactless mode of operation.

According to some embodiments of this disclosure, a substrate (or patch) having a patch booster antenna (PBA) with a patch coupler coil (PCC) component may be applied onto a contactless (ISO 14443) reader.

FIG. 7A shows a transponder (such as a smartcard) having an antenna module (AM) with a module antenna (MA), and a card body (CB) with a booster antenna (BA) including a coupler coil (CC) component. The antenna module (AM) may be referred to as a chip module.

A contactless reader is shown. The contactless reader has an antenna (reader antenna).

A separate substrate, or patch, is shown. The patch has a patch booster antenna (PBA) which may include a patch coupler coil (PCC). The patch booster antenna (PBA) may resemble the booster antenna (BA) in the card body (CB) of the transponder, and may include a patch coupler coil (PCC) which resembles the coupler coil (CC) of the transponder booster antenna (BA).

The patch is shown disposed between the contactless reader and the transponder. The patch may be capable of communicating with the reader at a distance of between 1-5 cm from the reader. The transponder may be capable of communicating with the patch at a distance of between 1-5 cm from the patch. The patch may be applied to, such as adhered to, a surface of the reader. All dimensions set forth herein are approximate and exemplary.

FIG. 7B shows an antenna module (AM) with a module antenna (MA), coupling with the reader via the patch, without requiring a card body (CB) and booster antenna (BA). The antenna module (AM) may be incorporated in a small form factor tag, smaller than a conventional smartcard. The antenna module (AM) may be referred to as a chip module.

In either one of the embodiments shown in FIGS. 2A and 2B, the chip module (or antenna module (AM)) is on a separate substrate from the patch booster antenna (PBA). The patch booster antenna (PBA) and the chip module (AM) are near each other, but on different substrates. By using the patch with patch booster antenna (PBA), or “booster patch”, the read range of a contactless reader may be extended in a simple, straightforward manner. This may enable a small form factor transponder to comprise only a small chip module with a module antenna.

The chip module may comprise a laser-etched antenna which operates at 1.3 cm for an 8 contact module size, such as described in U.S. Ser. No. 14/281,876. The booster patch attached to the reader may concentrate the electromagnetic field around the patch coupler coil (PCC) to communicate directly with the laser-etched antenna.

There has thus been disclosed,

1. A substrate or patch comprising a patch booster antenna (PBA) and suitable to be disposed on a contactless reader to enhance coupling between the reader and a transponder.

2. The patch of 1, wherein the patch booster antenna (PBA) comprises a patch coupler coil (PCC).

3. The patch of 1, wherein the transponder is a small form factor tag.

4. The patch of 1, wherein the transponder does not have a booster antenna (BA).

5. The patch of 1, wherein the transponder has a booster antenna (BA)

6. The patch of 5, wherein the booster antenna (BA) has a coupler coil (CC).

7. A method of improving coupling between a contactless reader and a transponder comprising:
providing a patch booster antenna (PBA) on a separate substrate disposed on the reader.

8. The method of 7, wherein the patch booster antenna (PBA) has a patch coupler coil (CC).

While the invention(s) has/have been described with respect to a limited number of embodiments, these should not be construed as limitations on the scope of the invention(s), but rather as examples of some of the embodiments. Those skilled in the art may envision other possible variations, modifications, and implementations that are also within the scope of the invention(s), and claims, based on the disclosure(s) set forth herein.

1. A dual interface smart card, comprising:
a card body (CB);
a booster antenna (BA) having a card antenna (CA) component extending around a periphery of the card body (CB) and a coupler coil (CC) disposed at an interior area of the card body (CB);
a dual interface antenna module (AM) having a module antenna (MA) and disposed so that the module antenna (MA) is inductively coupled with the coupler coil (CC).
a metallized layer (ML) having an opening for accepting the antenna module (AM).
wherein:
the opening in the metallized layer (ML) is sized so that the coupler coil (CC) is exposed.

2. The dual interface smart card of claim 1, wherein:
the metallized layer (ML) does not overlap the card antenna component.

3. Card body (CB) for a dual interface smart card (SC) comprising:
a metal foil (MF) layer incorporated into the card body (CB);
characterized in that:
the metal foil (MF) comprises a material selected from the group consisting of pure metals, alloys, aluminum, copper, metal nanoparticles, metal nanowires, carbon-based conductors, graphite, and exfoliated graphite;
further characterized by one of more of:
the metal foil comprises a very thin continuous layer deposited on the card body (CB);
the metal foil has a size matching an area of the card body (CB), or only a portion thereof;
the metal foil overlaps only the booster antenna (BA) or portions or components of the booster antenna;
the metal foil comprises multiple areas of foils which are deposited on or in the card body (CB);
the metal foil is perforated, segmented or discontinuous;
the metal foil is continuous, and has a thickness less than 15 nm;
the metal foil is discontinuous, and has a thickness greater than 15 nm;
the metal foil comprises a mesh;
the metal foil comprises metal particles of various sizes and shapes;
the metal foil partially covers the smartcard area, leaving exposed metal-free region at a coupling coil (CC) of the booster antenna (BA);
the metal foil reduces the quality (Q) of the booster antenna without having destructive effects on the coupling between the booster antenna (BA) and the antenna module (AM);
the metal foil, together with a booster antenna (BA) generates capacitance in the resonant circuit resulting in a broadening of a resonance curve;
the metal foil comprises a continuous loop;
the metal foil comprises) a discontinuous loop;
the metal foil comprises a resistor formed by narrowing a section of a metal loop; and
the metal foil comprises a conductive material having a sheet resistance on the order of only a few Ohms.

4. The card body (CB) of claim 3, wherein the metal foil is characterized by at least one of:
the metal foil is continuous, and has a thickness of less than 10 μm;
the metal foil is perforated;
the metal foil comprises a mesh; and
the metal foil comprises metal particles.

5. A method of improving coupling between a contactless reader and a transponder comprising:
providing a patch booster antenna (PBA) on a separate substrate disposed on the reader.

6. The method of claim 5, wherein the patch booster antenna (PBA) has a patch coupler coil (CC).
